(19) United States
(12) Patent Application Publication
(10) Pub. No.: US 2026/0031896 A1
(43) Pub. Date: Jan. 29, 2026

(54) METHODS FOR MANAGING TIMING ADVANCE OF AN INACTIVE UE

(71) Applicant: Google LLC, MOUNTAIN VIEW, CA (US)

(72) Inventors: Chih-Hsiang WU, Taoyuan City (TW); Ming-Hung TAO, Taoyuan City (TW)

(21) Appl. No.: 18/996,766

(22) PCT Filed: Aug. 2, 2023
(86) PCT No.: PCT/US2023/029276

§ 371 Date: Jan. 17, 2025

Related U.S. Application Data
(60) Provisional application No. 63/395,324, filed on Aug. 4, 2022.
(60) Provisional application No. 63/396,197, filed on Aug. 8, 2022.

(51) Int. Cl. H04B 7/185; H04W 76/27

(52) U.S. Cl. CPC H04B 7/18513; H04W 76/27

(57) ABSTRACT

Methods and wireless communication devices operating as network entities (such as base stations or distributed units of a distributed base station) in radio access networks using satellites manage efficiently timing advance information of user equipment (UE) transitioning from an inactive state to a connected state or performing small data transmission. A method performed by a network entity includes preserving pre-inactive-state time advance information pertinent to communications of the UE via a non-terrestrial network before the UE switches to an inactive state. The method further includes receiving, from the UE, a request for resuming an active state, and transmitting, to the UE, a resume-TA correction calculated using the pre-inactive-state TA information, when the UE does not provide a current full TA value with the request.

### FIELD OF THE DISCLOSURE

This document generally describes wireless communication methods and devices communicating using non-terrestrial networks (NTNs). More particularly the described embodiments relate to timing advance (TA) information of a user equipment (UE) transitioning from an inactive state to a connected state or performing small data transmission (SDT).

### BACKGROUND

This background description is provided for the purpose of generally presenting the context of the disclosed techniques. Work of the presently named inventors, to the extent it is described in this background section, as well as aspects of the description that may not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy terrestrial networks. However, the 3rd Generation Partnership Project (3GPP) organization has proposed to extend 5G communications to non-terrestrial networks (NTNs) with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, an RF transceiver is mounted on a satellite, an unmanned aircraft system (UAS), also called a drone, balloon, plane, or another suitable apparatus. For simplicity, the discussion below refers to all such apparatuses as satellites. In addition to satellites, an NTN may include sat-gateways that connect the NTN to a public data network, feeder links between sat-gateways and satellites, service links between satellites, and inter-satellite links (ISL) when satellites form constellations of satellites.

A satellite belongs to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, and LEO/MEO satellites are also known as the non-GSO (NGSO) satellites.

A GSO satellite can communicate with one or several sat-gateways deployed over a satellite targeted coverage area (e.g. a region or even a continent). A non-GSO satellite can communicate at different times with one or several serving sat-gateways. An NTN is designed to ensure service and feeder link continuity between successive serving sat-gateways, with sufficient time duration to proceed with mobility anchoring and hand-over.

A satellite may support a transparent or a regenerative (with on board processing) payload, and typically generates several beams for a given service area bounded by the field of view. The footprints of the beams typically have an elliptic shape and depend on the on-board antenna configuration and the elevation angle. For a transparent payload implementation, a satellite may apply RF filtering and frequency conversion and amplification, and not change the waveform signal. For a regenerative payload implementation, a satellite may apply RF filtering, frequency conversion and amplification, demodulation and decoding, routing, and coding/modulation. This approach is effectively equivalent to the satellite performing most of the functions of a base station, e.g., a gNB.

A UE communicating via an NTN experiences propagation delays when communicating via a satellite with terrestrial network entities, NEs of a radio access network, RAN. In this document, a network entity, NE, is a physical device operating as a base station, BS, a distributed unit, DU, of a BS or hosting core network, CN, functionality. In such scenarios, the UE and the RAN can cooperate to compensate for the propagation delay based on location information of the UE and the satellite. The RAN includes terrestrial NEs and satellites, i.e., a non-terrestrial network, NTN. The RAN is aware of the UE's serving satellite but may not be aware of exact UE location within area (cell) served via the satellite. The UE is able to evaluate the satellite-to-UE delay and reports it to the RAN, enabling the RAN to precisely estimate the round-trip-delay for scheduling UL transmissions. Without knowing the satellite-to-UE delay, the RAN has to schedule every UL transmission assuming the UE is at the edge of the cell (i.e., assuming the longest possible round-trip-delay for the cell). Such scheduling can significantly delay the UL transmission, especially, when the UE, in the RRC_INACTIVE (RRC being the acronym of Radio Resource Control) state, performs an RRC connection resume procedure or the small data transmission (SDT) procedure to communicate data. In these cases, such scheduling prolongs the entire RRC connection resume/SDT procedure and consequentially increases latency.

Conventionally, there is no adequate strategy regarding the UE providing the TA report when resuming the connection to the RAN after an inactive state or when performing a small data transmission, SDT, procedure (without leaving the inactive state). On one hand, the UE-to/from-satellite path may have changed during the UE's inactive state. On the other hand, automatic TA reporting wastes communication resources and time if the UE-to/from-satellite path only changed a nominal amount.

### SUMMARY

Generally speaking, the techniques described in this document allow an NE (i.e., BSs or units of a distributed BS) to manage TA information of UEs that selectively, according to a predetermined rule, transmit a TA report when resuming a connection with the RAN or when performing an SDT. The NEs are configured to preserve a UE's TA information when the UE enters an inactive state, and then use the UE's TA information in a manner depending on whether the UE provides a TA report when the UE initiates resuming a connection to the network or performs an SDT. The absence of a TA report from the UE while in the inactive state may indicate (i) that a difference between UE re-evaluated TA and the TA prior to the UE entering the inactive state is less than a predetermined threshold, (ii) that the UE uses the same satellite/cell as before entering the inactive state, and/or (iii) that the SDT size allows communicating the SDT using UL resources allocated in response to an SDT preamble random access. The NE may transmit, to the UE, an indication to transmit the TA irrespective of (i)-(iii). Selectively transmitting the TA report avoids TA-related signaling that wastes time and communication resources, while supporting both the UE and NE to use proper TA-related information for communicating via satellite.

### BRIEF DESCRIPTION OF THE DRAWINGS

FIG. 1A is a block diagram of a wireless communication system in which a user equipment and network entities implement the TA reporting techniques according to various embodiments.

FIG. 1B is a block diagram of a distributed base station, BS, with a centralized unit, CU, and a distributed unit, DU, the distributed BS being configured to operate in the system of FIG. 1A.

FIG. 2A is a block diagram illustrating a protocol stack for UE's communications with terrestrial BSs.

FIG. 2B is a block diagram illustrating a protocol stack for the UE of FIG. 1A to communicate with a CU and a DU;

FIG. 3A is a block diagram of a transparent payload NTN architecture;

FIG. 3B is a block diagram of a transparent payload NTN architecture, in which a BS connects to multiple satellites via the same sat-gateway;

FIG. 4A illustrates a user plane protocol stack for use with the NTN architecture illustrated in FIG. 3A;

FIG. 4B illustrates a control plane protocol stack for use with the architecture of FIG. 3A;

FIG. 5A illustrates the relationship between TA and propagation delay for UE-BS communications via a satellite.

FIG. 5B illustrates the relationship between the TA and the propagation delay for two different UEs served by the same satellite.

FIG. 6 illustrates the components of the full TA applied by the UE using a satellite (i.e., communicating via an NTN).

FIG. 7 illustrates a sequence of messages leading to the UE obtaining N_{TA} for the UL transmission.

FIG. 8A-8D are messaging diagrams illustrating scenarios in which a UE configured with a TA report configuration determines whether to send a TA report to a DU of a BS during an RRC connection resume procedure.

FIG. 9A-9D are messaging diagrams of scenarios in which the UE determines whether send a TA report to a new cell (NE/BS) other than the cell (NE/BS) the UE was connected to before entering an inactive state, upon performing an RRC connection resume procedure, when broadcasted (satellite-related) system information does not include a positive indication for UEs to provide the TA report.

FIG. 10A-10D are messaging diagrams of scenarios in which the UE determines whether to send a TA report to a new cell (NE/BS) other than the cell (NE/BS) the UE was connected to before entering an inactive state, upon performing the RRC connection resume procedure, when broadcasted system information includes a positive indication for the UEs to send the TA report.

FIG. 11A-11C are messaging diagrams of scenarios in which the UE previously configured with a TA report configuration determines whether to send a TA report during the Small Data Transmission (SDT) procedure.

FIG. 12A-12B are messaging diagrams of scenarios in which the UE determines whether to send a TA report to a new cell (NE/BS) other than the cell (NE/BS) the UE was connected to before entering an inactive state, upon initiating the SDT procedure with the new cell, when broadcasted system information of the new cell includes a positive indication for UEs to provide TA reports upon establishing/re-establishing/resuming the RRC connection with the new cell.

FIG. 13 is a messaging diagram of an exemplary scenario in which the UE determines not to report TA to a new cell (NE/BS) other than the cell (NE/BS) the UE was connected to before entering an inactive state, upon initiating the SDT procedure with the new cell, when broadcasted system information for the new cell does not include a positive indication for UEs to report TA upon establishing/reestablishing/resuming the RRC connection with the new cell.

FIG. 14 is a flow diagram of a method performed by a DU for determining and handling the differential k_offset value for the UE, according to an embodiment.

FIG. 15A is a flow diagram of a method performed by a DU for providing the UE with a differential k_offset value during the RRC connection resume procedure, according to an embodiment.

FIG. 15B is a flow diagram of a method performed by a DU for providing, to the UE, the differential k_offset value during the RRC connection resume procedure, without having the full TA value reported by the UE, according to an embodiment.

FIG. 16A is a flow diagram of a method performed by a DU for providing, to the UE, sufficiently large resources for reporting TA in specific RA procedures, according to an embodiment.

FIG. 16B is a flow diagram of a method performed by a DU for providing, to the UE, sufficiently large resources for reporting TA in an RA procedure, according to an embodiment.

FIG. 17 is a flow diagram of a method performed by a DU for controlling via the system information UEs to report TA in the RRC connection resume procedure, according to an embodiment.

FIG. 18A is a flow diagram of a method performed by a base station for determining the differential k_offset value for a UE during an RRC connection resume procedure, according to an embodiment.

FIG. 18B is a flow diagram of a method performed by a base station for determining the differential k_offset value for a UE during an RRC connection resume procedure, without having the full TA value reported by the UE, according to an embodiment.

FIG. 19A is a flow diagram of a method performed by a base station for determining the differential k_offset value for a UE in an SDT procedure, according to an embodiment.

FIG. 19B is a flow diagram of a method performed by a base station for determining the differential k_offset value for a UE in an SDT procedure, without having the full TA value reported by the UE, according to an embodiment.

FIG. 20 is a flow diagram of a method performed by a BS for controlling via the system information UEs to report TA in an SDT procedure, according to an embodiment.

FIG. 21 is a flow diagram of a method performed by an NE (e.g., a BS or a DU of a distributed BS) connected to a UE, according to an embodiment.

FIG. 22 is a flow diagram of a wireless communication method 2200 performed by an NE (e.g., a BS or a DU of a distributed BS) according to another embodiment.

FIG. 23 is a flow diagram of a communication method performed by an NE (e.g., a BS or a DU of a distributed BS) according to yet another embodiment.

FIG. 24 is a block diagram of a wireless communication device configured to perform the above-described methods for managing TA when an inactive UE resumes a RAN connection and/or initiates an SDT procedure according to an embodiment.

### DETAILED DESCRIPTION OF THE DRAWINGS

As discussed in more detail below, a user equipment, (UE), and/or a network entity, NE, of a radio access network, RAN, use the techniques described in this section for managing TA reporting when a UE transitions from an inactive state to an active state of a radio resource control protocol between the UE and the RAN and/or when the UE performs a Small Data Transfer, SDT.

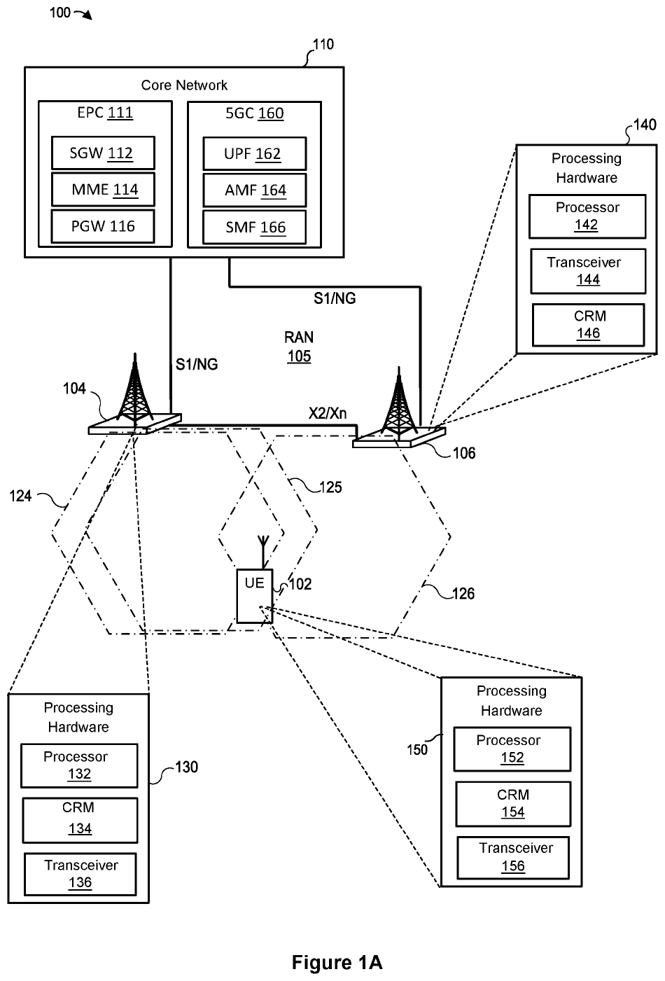

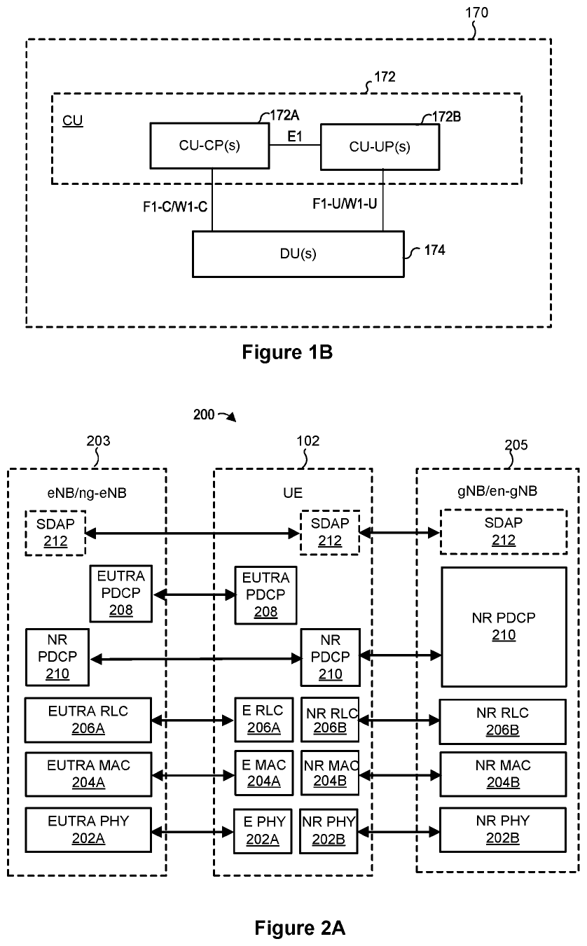

Referring first to FIG. 1A, a wireless communication system 100 includes a UE 102, a base station, BS, 104, a base station 106, and a core network, CN, 110. The base stations 104 and 106 operate in a RAN 105 connected to the core network, CN, 110. The CN 110 may be implemented as an evolved packet core, EPC, 111 or a fifth generation, 5G, core, 5GC, 160, for example. The CN 110 may also be implemented as a sixth generation, 6G, core in another example.

The base station 104 serves UEs within a cell 124, and the base station 106 serves UEs within a cell 126. If the base station 104 and/or 106 is a gNB, the cell 124 and/or 126, respectively, is an NR cell. If the base station 104 and/or 106 is an ng-eNB or eNB, the cell 124 and/or 126 is an evolved universal terrestrial radio access (E-UTRA) cell. The cells 124 and 126 may be in the same Radio Access Network Notification Areas (RNA) or different RNAs. In general, the RAN 105 includes any number of base stations, and each of the base stations covers (i.e., serve UEs within) one, two, three, or any other suitable number of cells. For example, base station 104 may also cover cell 125. The UE 102 supports at least one of a 5G NR (or simply, “NR”) or E-UTRA air interface to communicate with one or both base stations 104 and 106. Each of the base stations 104, 106 connects to the CN 110 via an interface (e.g., S1 or NG interface). The base stations may also be interconnected via an interface (e.g., X2 or Xn interface for interconnecting NG RAN nodes).

CN 110 may be hosted by one or more physical devices that may be collocated. In this document, base stations and physical devices hosting core network functions/modules may be called network entities, NEs. Among other components, the EPC 111 includes a Serving Gateway, SGW, 112, a Mobility Management Entity, MME, 114, and a Packet Data Network Gateway, PGW, 116. The SGW 112 in general is configured to transfer user-plane packets related to audio calls, video calls, Internet traffic, etc. The MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. Similarly, among other components, 5GC 160 includes a User Plane Function, UPF, 162, an Access and Mobility Management Function, AMF, 164, and/or a Session Management Function, SMF, 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports (i.e., covers, serves UEs within) the cell 124, and the base station 106 supports a cell 126. The cells 124 and 126 can partially overlap, so that the UE 102 selects, reselects, or is handed over from one of the cells 124 and 126 to the other. To directly exchange messages or information, the base station 104 and base station 106 support an X2 or Xn interface. In general, the CN 110 connects to any suitable number of base stations supporting NR cells and/or EUTRA cells.

As discussed in detail below, the UE 102 and/or NEs of the RAN 105 (e.g., BSs 104 and/or 106) may utilize the techniques described in this section when the radio connection between the UE 102 and the RAN 105 is suspended, e.g., when the UE 102 operates in an inactive state that includes RRC_IDLE and RRC_INACTIVE states of the RRC protocol.

The base station 104 is equipped with processing hardware 130 that includes one or more general-purpose processors (e.g., CPUs) 132 and a non-transitory computer-readable memory 134 storing instructions that the one or more general-purpose processors execute. Additionally or alternatively, the processing hardware 130 may include special-purpose processing units. The processor 132 is configured to process data that the base station 104 receives in the uplink direction or transmits in the downlink direction according to various techniques described in this section. The processing hardware 130 also includes a transceiver 136 (term that here stands also for antenna(s) and radio-frequency front-end electronics that are not illustrated separately in this figure) configured to transmit the data in the downlink direction and to receive data in the uplink direction. The base station 106 includes generally similar components. In particular, components 140, 142, 144, and 146 of the base station 106 are similar to the components 130, 132, 134, and 136, respectively.

The UE 102 is equipped with processing hardware 150 that includes one or more general-purpose processors 152 such as CPUs and non-transitory computer-readable memory 154 storing machine-readable instructions executable on the one or more general-purpose processors, and/or special-purpose processing units. The processor 152 is configured to process data that the UE 102 transmits in the uplink direction and/or receives in the downlink direction. The processing hardware 150 can also include a transceiver 156 (term that here stands also for antenna(s) and radio-frequency front-end electronics that are not illustrated separately in this figure) configured to transmit and receive data.

FIG. 1B is a block diagram of a distributed base station 170. Any one or both base stations 104 and 106 in FIG. 1A may use a distributed BS architecture. The base station 170 includes a centralized unit, CU, 172, and one or more distributed units, DUs, 174 (only one illustrated). The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a Packet Data Convergence Protocol, PDCP, controller, an RRC controller, and/or an RRC inactive controller. In some implementations, the CU 172 can include a radio link control, RLC, controller configured to manage or control one or more RLC operations or procedures. In further implementations, the CU 172 does not include an RLC controller.

In some implementations (such as the one illustrated in FIG. 1B), the CU 172 includes a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

The DU 174 (which may be one of plural DUs of the distributed base station) contains processing hardware that can include one or more general-purpose processors (e.g., CPUs) and computer-readable memory storing machine-readable instructions executable on the one or more general-purpose processors, and/or special-purpose processing units. For example, the processing hardware can include a Medium Access Control, MAC, controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. For the embodiments described in this section, the RAN 105 supports Non-Terrestrial Network (NTN) functionality.

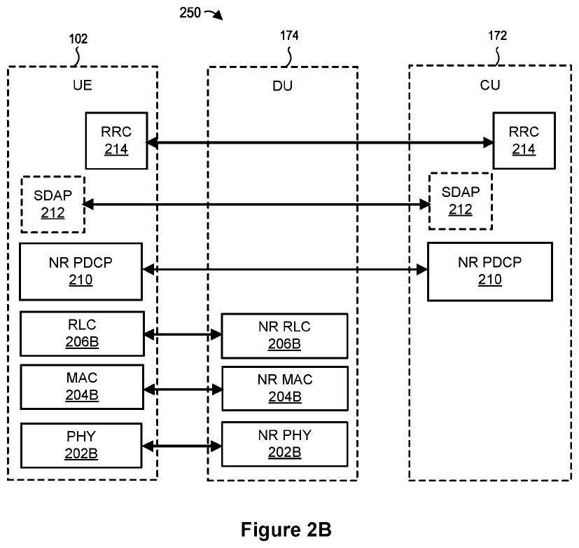

FIG. 2A is a block diagram illustrating a protocol stack 200 for UE's communications with terrestrial base stations such as eNB/ng-eNB 203 and a gNB/en-gNB 205 (e.g., that may correspond to the base stations 104 and/or 106 in FIG. 1A).

A physical layer, PHY, 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210, in turn, can provide data transfer services to Service Data Adaptation Protocol, SDAP, 212 or a radio resource control, RRC, sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol, IP, layer, layered directly or indirectly over the PDCP layer 208 or 210) that can be referred to as service data units, SDUs, and output packets (e.g., to the RLC layer 206A or 206B) that can be referred to as protocol data units, PDUs. Except where the difference between SDUs and PDUs is relevant, this document for simplicity refers to both SDUs and PDUs as “packets.”

On a control plane, the EUTRA PDCP sublayer 208 and the NR PDCP sublayer 210 can provide signaling radio bearers, SRBs, or RRC sublayer (not shown in FIG. 2A) to exchange RRC messages or non-access-stratum, NAS, messages, for example. On a user plane, the EUTRA PDCP sublayer 208 and the NR PDCP sublayer 210 can provide Data Radio Bearers, DRBs, to support data exchange. Data exchanged on the NR PDCP sublayer 210 can be SDAP PDUs, IP packets, or Ethernet packets.

FIG. 2B illustrates, in a simplified manner, an example protocol stack 250, which the UE 102 can communicate with a DU 174 and a CU 172. The radio protocol stack 200 in FIG. 2A is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

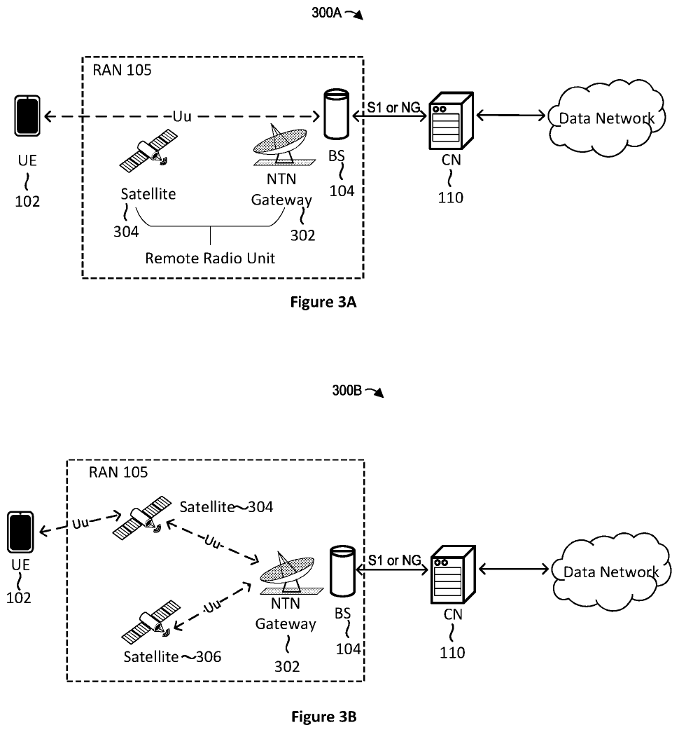

FIG. 3A illustrates a certain type of NTN deployment referred to as transparent payload architecture, which involves a satellite gateway 302 and a “transparent” satellite 304 for extending the range of the Uu interface. The satellite 304 implements a frequency conversion and a Radio Frequency (RF) amplifier in both the uplink and downlink directions. The satellite function is similar to that of an analog RF repeater. As a result, the satellite 304 repeats the Uu radio interface from the feeder link (between the NTN gateway and the satellite) to the service link (between the satellite and the UE) in the downlink direction and vice versa in the uplink direction. The Satellite Radio Interface (SRI) on the feeder link is the Uu, and the NTN gateway 302 supports all necessary functions to forward the signal of the Uu interface. The NTN gateway 302 may be placed at the same location as the base station (e.g., eNB or gNB) 104, or may be connected to the base station 104 via a wired link. It is also possible to connect more than one NTN gateway to a base station. Different transparent satellites may be connected to the same base station on the ground, via the same NTN gateway, or via different NTN gateways.

FIG. 3B illustrates a different type of NTN deployment with two different satellites (304 and 306) connected to the same base station 104 via the same NTN gateway 302, the two satellites (304 and 306) covering areas (which may partially overlap) on the Earth surface using two different Physical Cell IDs (PCIs).

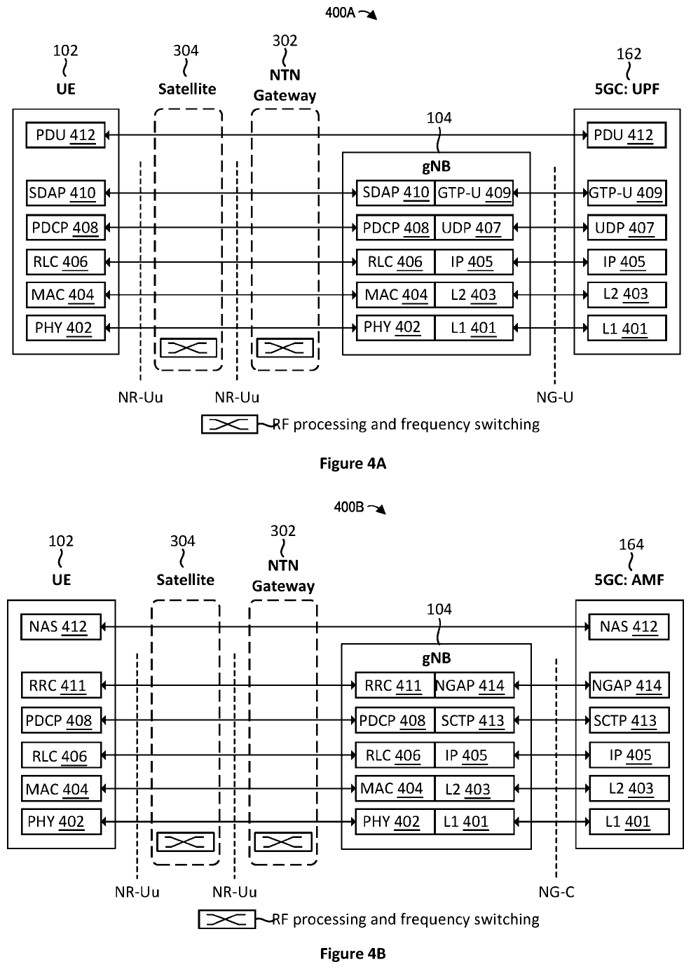

The NTN user plane protocol stack, UPPS, involving the UE 102, the satellite 304, the NTN gateway 302, the NR base station (i.e., gNB) 104, and the UPF 162 is illustrated in FIG. 4A. The diagram of the NTN UPPS is similar to that of the terrestrial network, TN, with the addition of two new nodes, the satellite 304 and the NTN gateway 302, being placed in the middle of the NR-Uu interface. The UE-to/from-gNB communications employ physical layer 402, MAC layer 404 and Radio Link Control, RLC, layer 406. Further, the UE-to/from-gNB communications employ a packet Data Convergence Protocol, PDCP, 408 and a Service Data Adaptation Protocol, SDAP, 410. The gNB-to/from-UPF communications employ an L1 layer 401 (i.e., 5G Physical Layer), an L2 layer 402 (i.e., 5G Data Link Layer) and an Internet Protocol, IP, 405. Further, the gNB-to/from-UPF communications employ a User Datagram Protocol, UDP, 407 and a GPRS Tunnelling Protocol, for carrying user data, GTP-U 409 (here acronym GPRS stands for General Packet Radio Services).

The NTN control plane protocol stack, CPPS, illustrated in FIG. 4B is also similar to that of the TN. The differences between the UPPS in FIG. 4A and the CPPS in FIG. 4B are now discussed. Instead of SDAP 410 in UPPS, the CPPS includes an RRC layer 411. Further, the UDP 407 and the NGAP 409 are replaced by the Stream Control Transmission Protocol, SCTP, 413, and the Next Generation Application Protocol, NGAP, 414. Descriptions of these protocols and communication layers can be found in contemporaneous 3GPP technical specifications.

In terms of the satellite moving pattern, there are three types of service links that are supported in NTN:
Earth-fixed for satellites that provide beam(s) continuously covering the same geographical areas (e.g., GEO/GSO satellites),
Quasi-Earth-fixed for satellites that provide beam(s) covering one geographic area for a limited period and a different geographic area during another period (e.g., LEO/MEO satellites capable of using steerable beams),
Earth-moving for satellites that provide beam(s) whose coverage area slides over the Earth surface (e.g., LEO/MEO satellites using fixed or non-steerable beams).

Thus, an eNB connected via NTN can provide either quasi-Earth-fixed cell coverage or Earth-moving cell coverage using LEO/MEO satellites. The eNB provides Earth fixed cell coverage using GEO satellites.

Although the transparent payload architecture illustrated in FIGS. 3A/3B is the current focus of the 3GPP development, the regenerative payload architecture that installs the BS functions on the satellite is also a possible NTN deployment. In such an architecture, the Uu only exists between the satellite and the UE. In general, the techniques of this document can apply to the transparent payload architecture as well as the regenerative payload architecture.

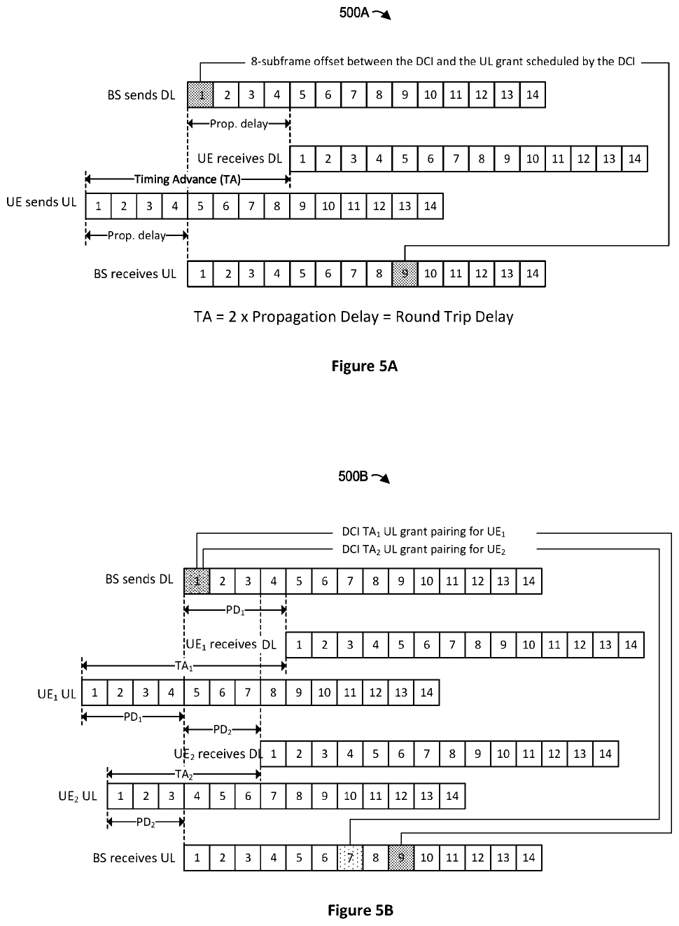

When time-domain resources are allocated in a TN, the interval between the DCI scheduling the UL data transmission and the PUSCH carrying the UL data is indicated via a k2 value, where the k2 value is indicated in the DCI in terms of slots. Similarly, the interval between the PDSCH carrying the DL data and the PUCCH carrying UE's HARQ feedback related to the received DL data is indicated via a k1 value, where the k1 value is indicated in the DCI scheduling the DL data (also in terms of slots). When time-domain resources are allocated in NTN, in addition to the above-mentioned k1, k2 value, UE needs to further delay the PUCCH or the PUSCH transmission, to compensate for the signal propagation time. This additional delay is known as the scheduling delay ‘k_offset’ and it accounts for the round-trip-delay between the UE and the base station. FIG. 5A illustrates an example demonstrating the relationship between the k_offset and the UE-to/from-BS propagation time in an NTN scenario. In this example, the DL signal propagation time corresponds to 4 slots, and hence the UE DL timing is 4-slot behind the BS DL timing. To align the BS DL timing with the BS UL timing, the UE needs to perform any PUSCH/PUCCH transmission with a timing advance (TA) equal to 8 slots (i.e., the round-trip-delay or two times the propagation time, because the UL propagation time is the same as the DL propagation time). In this case, when the BS schedules an UL transmission for the UE, it has to make sure the shortest interval between the UL transmission and the PDCCH scheduling the UL transmission is 8 slots, otherwise there isn't enough time for the UE to prepare/perform the UL transmission by applying the 8-slot TA. That is, the k_offset in this case has to be at least 8 slots long.

FIG. 5B illustrates another example involving two different UEs, UE₁ and UE₂, served by the same BS/satellite. In this example, UE₂ is closer to the BS compared to UE₁, and hence the propagation delay from the BS toward UE₂ (3 slots) is also smaller compared to that from the BS toward UE₁ (4 slots). As a result, UE₁ and UE₂ need to apply the TAs equal to 8 slots and 6 slots, respectively, to align the BS UL timing with the BS DL timing. Because UE₁ and UE₂ apply different TAs, the k_offset values for UE₁ and UE₂ are also different. In this example, the k_offset value for UE₁ is 8 slots while the k_offset value for UE₂ is 6 slots.

In the NTN environment, in addition to the k1 and k2 values signaled in the PDCCH, the BS needs to signal the k_offset value to the UE prior to the PDCCH delivery so that the UE can perform the UL transmission at the correct timing (e.g., k1+k_offset or k2+k_offset) instructed by the BS. k_offset is delivered to the UE via two components: 1) cell-specific scheduling offset ‘cell-specific k_offset’, and 2) the UE-specific scheduling offset ‘differential k_offset’. The ‘cell-specific k_offset’ is the common part of the k_offset value that is identical to all the UEs within the same cell. The ‘differential k_offset’ is the delta value between the actual k_offset value of a UE and the cell-specific k_offset value and it is signaled to each UE individually. In one implementation, the cell-specific k_offset value is broadcast in the (satellite-related) system information, which reflects the actual k_offset value of the UE that is farthest away from the satellite; the differential k_offset value is signaled to the UE individually via a specific MAC CE named ‘differential Koffset MAC CE’, which is then subtracted from the cell-specific k_offset value to obtain the actual k_offset value (i.e., the further the UE is away from the satellite, the smaller the differential k_offset is).

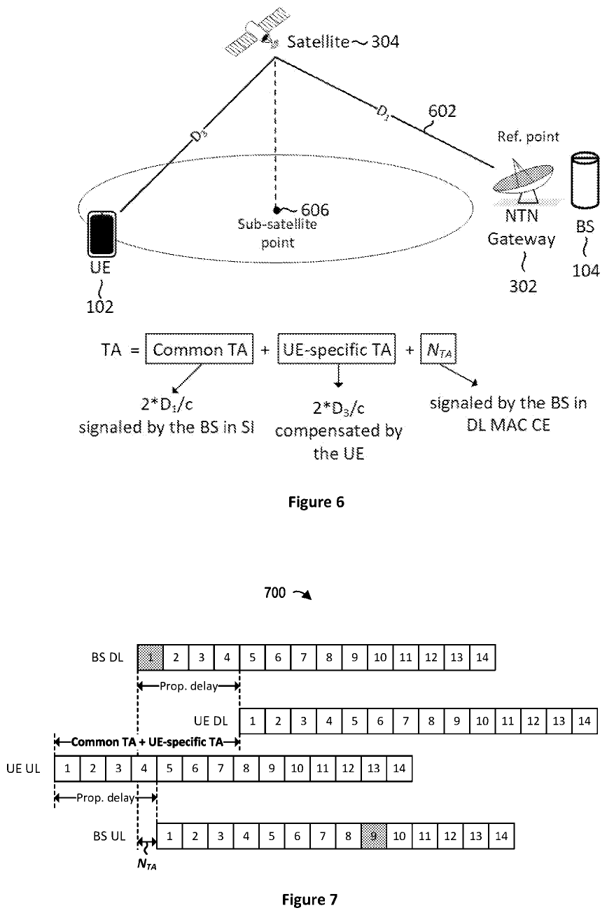

In order to provide the UE with an accurate differential k_offset value, the BS needs to know exactly the round-trip-delay between the UE and the BS. Because the round-trip-delay is equivalent to the TA applied by the UE upon performing the UL transmission, the BS can determine the differential k_offset value for a UE by obtaining the TA applied by the UE. In communications via an NTN (i.e., satellite 304) as illustrated in FIG. 6, the UE applies a TA that has three components: 1) a common TA, 2) a UE-specific TA, and 3) a TA correction N_{TA}. The common TA (i.e., common for all UEs communicating with the same BS via the same satellite) equals two times the BS-to/from-satellite propagation time (i.e., 2*D₁/c for co-located NTN gateway 302 and BS 104, where c is the speed of light), if the uplink time synchronization reference point is located at the BS 104. The UE-specific TA equals two times the satellite-to/from-UE propagation time, depending on the distance D₃ between the satellite 304 and UE 102: UE-specific TA=2*D₃/c. The common TA is known to the BS and may be broadcasted in a system information block. The UE-specific TA is known to the UE but not to the BS. The UE may report TA information to make the BS aware of the UE-specific TA.

Before receiving the TA correction N_{TA} from the BS, the UE performs the UL transmission (e.g., random access preamble transmission, PUSCH transmission, or PUCCH transmission) by applying both the common TA and the UE-specific TA. FIG. 7 illustrates an example demonstrating how a UE obtains N_{TA} upon performing the UL transmission. In this example, the propagation delay is 4-slot long, and hence the UE DL timing is 4-slot behind the BS DL timing. UE first determines the UE-specific TA by obtaining the distance between the UE and the connected satellite, which can be calculated based on the GNSS information available at the UE side and the ephemeris information provided by the network. The UE then acquires the common TA by acquiring the satellite-related system information and applies both the common TA and the UE-specific TA while performing the UL transmission. In this example, even after UE applies both the common TA and the UE-specific TA, the BS UL timing is still slightly behind the BS DL timing. Hence, the BS sends the Timing Advance Command (TAC) MAC CE to inform the UE of the amount of the timing advance UE needs to additionally apply to align the BS DL timing with the BS UL timing. The extra amount of timing advance provided in the TAC MAC CE becomes the N_{TA} of the UE and needs to be applied by the UE starting from the next UL transmission. Although in this example the N_{TA} is a positive value because the BS UL timing is behind the BS DL timing, the N_{TA} can be a negative value for the case when the BS UL timing is ahead of BS DL timing. After obtaining the N_{TA}, the UE is able know and apply the full TA (Common TA+UE-specific TA+N_{TA}) while performing the UL transmission.

Different from the terrestrial BS, the NTN BS does not know the full TA that the UE applies even after sending the Timing Advance Command MAC CE (i.e., N_{TA}) to the UE, because the UE-specific TA (i.e., part of the full TA) compensated by the UE is not known to the BS. As a result, the NTN BS is not able to estimate the round-trip-delay and has to schedule the UL transmission with an extra delay (i.e., k_offset) equivalent to the worst-case (i.e., longest) round-trip-delay between the UE and the BS. To make the NTN BS aware of the full TA of a UE, 3GPP UEs are now configured to report a full TA by sending a TA report MAC CE to the BS. The UE reports its full TA to the BS under several circumstances. For example, the UE may receive an RRC message including a TA report configuration (i.e., including the tar-Config Information Element). The TA report configuration may include an offset value X_{offset}, which is used by the UE to determine whether to send another TA report, that is, when the TA currently applied by the UE differs by more than X_{offset} from the last-reported TA. In another example, upon hand over to another BS or upon reestablishing the RRC connection to another BS, the UE sends the TA report to the new BS if instructed (i.e., receiving an indication) in the handover command or in a system information broadcast message.

However, conventional strategies are not clear whether and under which conditions the UE in the RRC_INACTIVE state to report its full TA when attempting to resume its RRC connection (i.e., upon sending the RRC connection resume request message to the BS). If the UE does not report its full TA during the RRC connection resume procedure, the BS does not know the round-trip-delay and has to assume the worst case (i.e., the longest round-trip-delay) while scheduling the UL grants during the RRC connection resume procedure, which would prolong the entire RRC connection resume procedure and consequentially increase the latency of the Mobile Originating (MO) or Mobile Terminating (MT) data. On the other hand, forcing every UE to report its full TA during the RRC connection resume procedure is not resource-efficient, because it would require the network to allocate a larger MSG3 grant or MSGA PUSCH resource globally, which may end up wasting resources because the TA for particular UEs (e.g., the stationary UEs) may not change since the last time the UE reported its TA.

The conventional approach is also not clear whether the UE in the RRC_INACTIVE state reports its full TA to the BS upon initiating or during an SDT procedure. If the UE transmits all the SDT data in one-shot, UE reporting of its TA is inefficient because the UE immediately returns to the RRC_INACTIVE state and hence won't be able to utilize/apply the UE-specific scheduling offset (i.e., differential k_offset) determined by the BS. On the other hand, if the UE has subsequent data transmissions following the first small data transmission, hindering the UE from reporting its full TA yields a more-conservative-than-necessary scheduling for the subsequent data transmissions and hence increases the overall data latency. This document proposes techniques that minimize the UL data latency and avoid unnecessary signaling overhead for determining whether and when to report UE's TA.

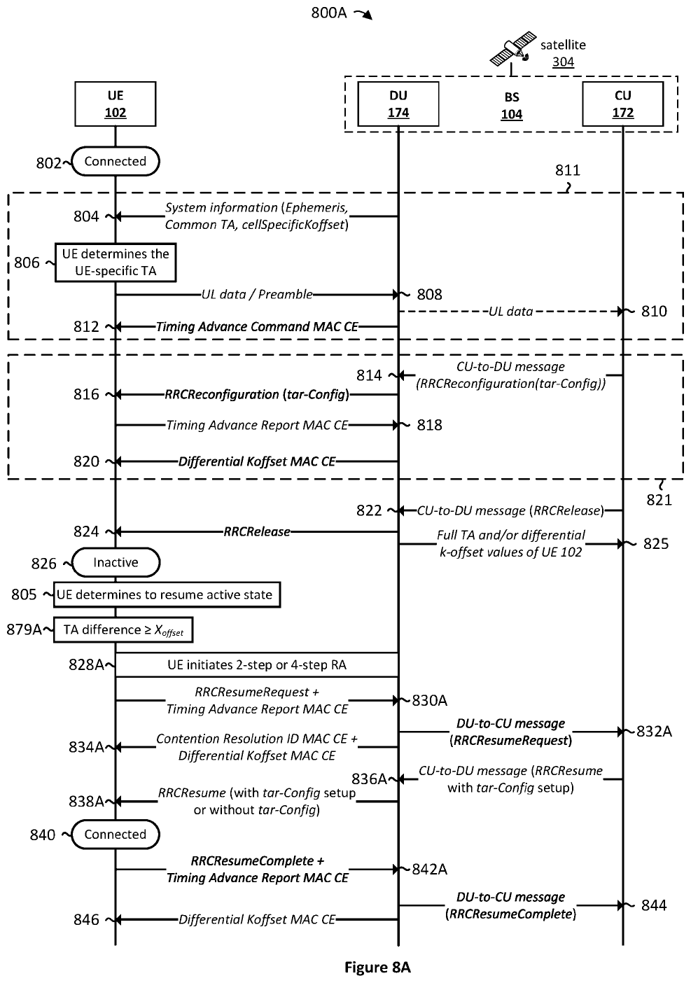

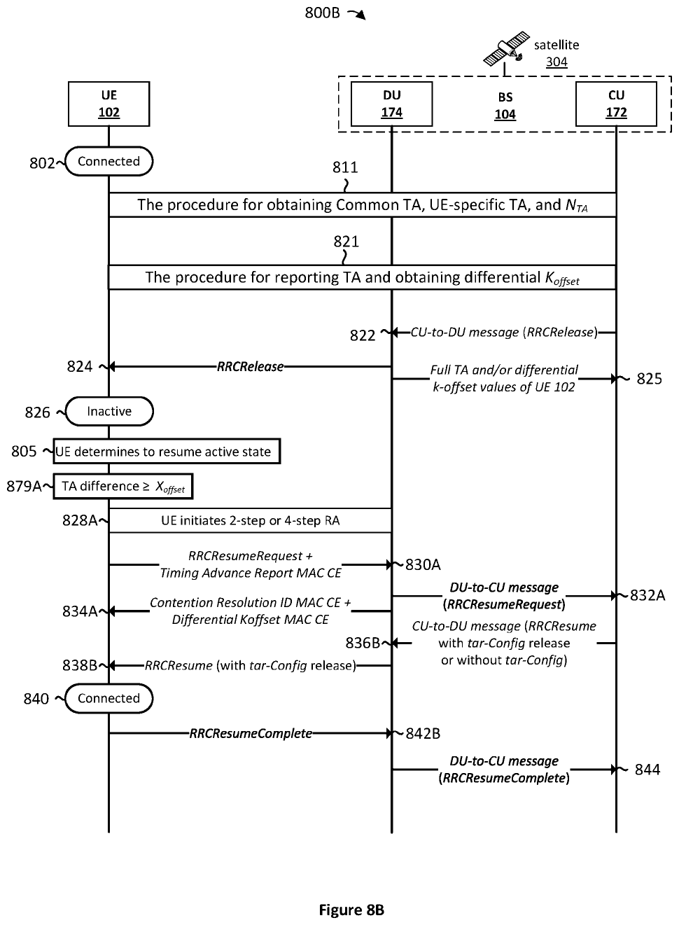

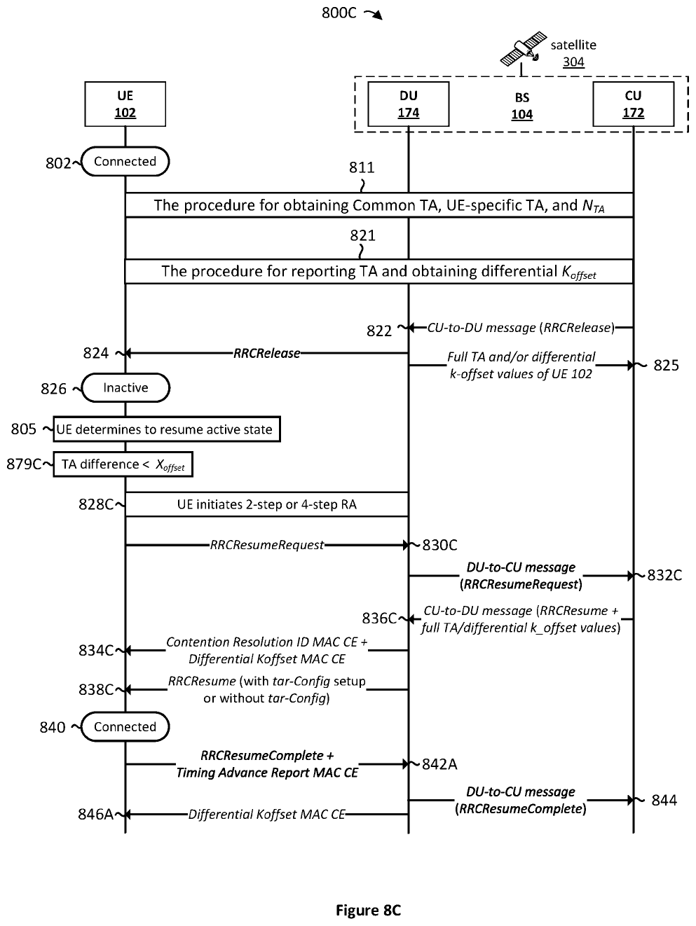

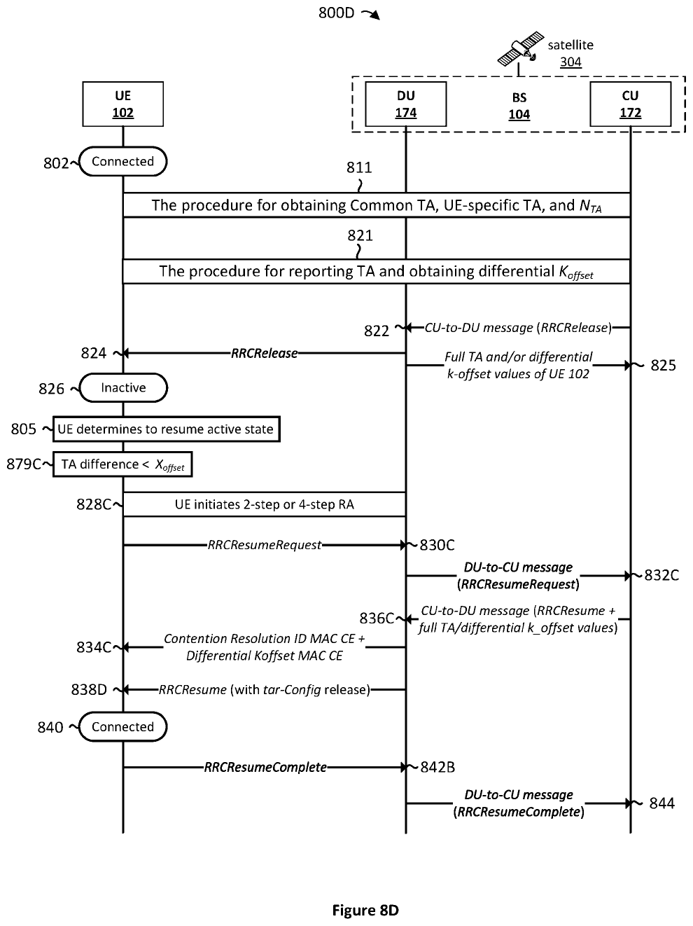

FIGS. 8A-13 illustrate several scenarios in which a UE and/or a network element, NE, (e.g., a BS, a DU or a CU) perform techniques related to TA reporting by a UE in an inactive state. In these figures, time flows from the top of the page to the bottom, that is, a first action (such as a signal transmission) occurs before a second action represented underneath the first action. Similar events in FIGS. 8A-13 are labeled with similar reference numbers, with differences discussed below where appropriate. For example, event 802 is similar to events 902, 1002, 1102, 1202, 1302. To simplify the following description, the term “inactive state” represents the RRC_INACTIVE or RRC_IDLE state, and the term “connected state” or “active state” represents the RRC_CONNECTED state.

FIG. 8A is a messaging diagram of a scenario 800A in which UE 102 communicates with BS 104 (more precisely with DU 174 of BS 104) via satellite 304. The BS 104 includes a CU 172 and a DU 174. The UE 102 initially operates 802 in a connected state and connects to the BS 104 via the service link provided by the satellite 304. The UE 102 then receives 804 system information containing NTN-specific information including the ephemeris, common TA, and cell-specific k_offset (i.e., cellSpecifickoffset) from the DU 174. The UE 102 may receive the system information before transitioning to the connected state. After that, the UE 102 obtains its GNSS coordinate, calculates the distance between the UE 102 and the satellite 304 according to the obtained ephemeris information and GNSS coordinate, and determines 806 the UE-specific TA based on the calculated distance. At a later time, the UE 102 applies both the common TA and UE-specific TA while transmitting 808 a Random Access (RA) preamble or UL data to the DU 174. Upon receiving the RA preamble or the UL data, the DU 174 first forwards 810 the UL data (if not the RA preamble) to the CU 172, determines the value of N_{TA} for the UE 102, and then transmits 812 to the UE 102 the Timing Advance Command MAC CE including the determined N_{TA} value. The events 804, 806, 808, 812, and optionally 810 are collectively referred to in FIG. 8A (and collectively illustrated in following figures) as a procedure 811 for obtaining Common TA, UE-specific TA, and N_{TA}.

At a later time, the CU 172 generates an RRC reconfiguration message including a TA report configuration (e.g., tar-Config) for the UE 102, and transmits 814 a CU-to-DU message (e.g., DL RRC Message Transfer message) including the RRC reconfiguration message (e.g., RRCReconfiguration message) to the DU 174. The DU 174, in turn, transmits 816 the RRC reconfiguration message to the UE 102. In some implementations, the CU 172 receives a DU-to-CU message (e.g., a UE Context Modification Required message or a UE Context Modification Response message) including the TA report configuration from the DU 174. In response to the TA report configuration, the UE 102 transmits 818 an UL MAC PDU including a Timing Advance Report MAC CE to the DU 174, where the Timing Advance Report MAC CE includes a first full TA value (i.e., common TA+UE-specific TA+N_{TA}) applied by the UE for UL transmission. After (e.g., in response to) receiving the Timing Advance Report MAC CE, the DU 174 transmits 820 a Differential Koffset MAC CE including a first differential k_offset value to the UE 102. In some implementations, the DU 174 determines the first differential k_offset value based on the first full TA value reported by the UE 102 and the cell-specific k_offset value. The events 814, 816, 818, and 820 are collectively referred to in FIG. 8A (and collectively illustrated in following figures) as a procedure 821 for reporting TA and obtaining differential k_offset (N_{TA}).

In response to the RRC reconfiguration message, the UE 102 transmits an RRC reconfiguration complete message to the DU 174, which in turn transmits the RRC reconfiguration complete message to the CU 174. In some implementations, the UE 102 includes the RRC reconfiguration complete message in the UL MAC PDU of event 818. In other implementations, the UE 102 transmits the RRC reconfiguration complete message to the DU 174 in a different UL MAC PDU than the UL MAC PDU of event 818.

After the DU 174 transmits the first differential k_offset value to the UE 102, the CU 172 determines data inactivity of the UE 102 (i.e., the UE 102 in the connected state has no data exchange with the BS 104). In response to the determination, the CU 172 sends 822 a CU-to-DU message (e.g., a UE Context Release Command message) that includes an RRC release message (e.g., RRCRelease message) to transition the UE 102 to the inactive state. In some implementations, the RRC release message includes a SuspendConfig Information Element (IE) configuring the UE 102 to transition to the inactive state. In turn, the DU 174 transmits 824 the RRC release message to the UE 102, and in some implementations, the DU may transmit 825 a DU-to-CU message including the first full TA value and/or the first differential k-offset value of the UE 102 to the CU 172. The DU may release/discard the first full TA value and/or the first differential k-offset value of the UE 102 after transmitting 825 the DU-to-CU message including the first TA value and/or the first differential k-offset value of the UE 102 to the CU 172. In response to the RRC release message or the SuspendConfig IE, the UE 102 then preserves the TA report configuration (e.g., the X_{offset} value provided in the tar-Config IE) and transitions 826 to the inactive state.

At a later time, the UE 102 in the inactive state determines 805 to resume an active state, that is, the UE initiates an RRC connection resume procedure to transmit UL data, respond to a paging message received from the DU 174, or perform the RAN-based area notification update, RNAU. Meanwhile, the UE 102 determines 879A that the difference between the full TA value currently applied by the UE (i.e., the second full TA value) and the first full TA value reported at event 818 is equal to or larger than the value X_{offset} configured in the TA report configuration (i.e., fulfills a threshold criterion), and hence determines to transmit the second full TA value to the BS during the RRC connection resume procedure. In response to the determination, the UE 102 initiates 828A a Random Access (RA) procedure with the DU 174 and selects a RA preambles group by taking into account the size of the TA Report MAC. In some implementations, the RA procedure is a four-step RA procedure. In other implementations, the RA procedure is a two-step RA procedure. In response to initiating the RA procedure, the UE 102 transmits an RA preamble of the selected RA preambles group to the DU 174. In case of the four-step RA procedure, the DU 174 transmits an RA response to the UE 102 in response to the RA preamble, where the RA response includes an UL grant that is used by the UE 102 to transmit 830A an UL MAC PDU (MPDU) including an RRC resume request message (e.g., RRCResumeRequest message) and a TA Report MAC CE containing the second full TA value to the DU 174. In case of the two-step RA procedure, the UE 102 transmits 830A the MPDU including an RRC resume request message and a TA Report MAC CE containing the second full TA value to the DU 174 using an UL grant indicated in system information broadcast by the DU 174.

Upon receiving the UL MPDU including the RRC resume request message and the TA Report MAC CE, the DU 174 transmits 832A a DU-to-CU message (e.g., Initial UL RRC Message Transfer message) including the RRC resume request message to the CU 172, and also transmits 834A a DL MPDU including a Contention Resolution ID MAC CE to the UE 102 for contention resolution. In some implementations, the DU 174 can include, in the DL MPDU at event 834A, a Differential Koffset MAC CE including a second differential k_offset value. Alternatively, the DU 174 can transmit the Differential Koffset MAC CE at event 838A. In some implementations, the DU 174 determines the second differential k_offset value based on the second full TA value reported by the UE 102 and the cell-specific k_offset value.

In response to the RRC resume request message, the CU 172 transmits 836A a CU-to-DU message including an RRC resume message (e.g., RRCResume message) to the DU 174, where the RRC resume message sets up a new TA report configuration for the UE 102 (i.e., includes a SetupRelease {TAR-Config} type with the choice ‘setup’). The new TA report configuration at event 836A can be similar to or different from the TA report configuration at event 814. The DU 174 in turn transmits 838A the RRC resume message to the UE 102. Upon receiving the new TA report configuration, the UE 102 replaces the TA report configuration received at event 814 with the TA report configuration received at event 838A. In some implementations, the DU 174 receives the CU-to-DU message before transmitting the Contention Resolution ID MAC CE to the UE 102. In such cases (i.e., event 836A occurs before event 834A), the DU 174 can transmit a DL MAC PDU including the Contention Resolution ID MAC CE, and the RRC resume message to the UE 102 (i.e., 834A and 838A can be combined), and may also include the Differential Koffset MAC CE in the DL MAC PDU. In some implementations, the RRC resume message in 836A/838A does not contain a TA report configuration (i.e., excluding the tar-Config IE), which causes the UE 102 to apply the TA report configuration that it preserved before transitioning to the inactive state in event 824.

Upon receiving the RRC resume message including a new TA report configuration or without including a tar-Config IE, the UE 102 transitions 840 to the connected state, and transmits 842A an UL MPDU including an RRC resume complete message (e.g., RRCResumeComplete message) and a TA Report MAC CE containing a third full TA value to the DU 174. The DU 174 in turn transmits 844 a DU-to-CU message (e.g., UL RRC Message Transfer message) including the RRC resume complete message to the CU 174. After receiving the TA Report MAC CE, the DU 174 determines the third differential k_offset value based on the third full TA value reported by the UE 102 and the cell-specific k_offset value. In some implementations, the DU 174 can transmit 846 the Differential Koffset MAC CE to the UE 102. In some implementations, if the determined third differential k_offset value is similar to the second differential k_offset value that the DU 172 transmitted at event 834A, the DU 172 may omit event 846 (i.e., not transmit the Differential Koffset MAC CE). Note that steps 842A, 844 and 846 are likely but not required.

In some implementations, in response to the event 838A, the UE 102 transmits 842A an UL MPDU without including a third full TA value to the DU 174, because the UE 102 has already reported the second full TA value in the same RRC resume procedure, and the difference between the third full TA and the second full TA is less than the value X_{offset} configured in the TA report configuration.

FIG. 8B is a messaging diagram of a scenario 800B that is similar to the scenario 800A illustrated in FIG. 8A. The differences between FIGS. 8A and 8B are discussed below. In response to transmitting 832A a DU-to-CU message including the RRC resume request message to the CU 172, the DU 174 receives 836B a CU-to-DU message including an RRC resume message that releases the first TA report configuration (i.e., includes a SetupRelease {TAR-Config} type with the choice ‘release’). In turn, the DU 174 transmits 838B the RRC resume message with an indication to release the first TA report configuration to the UE 102.

Upon receiving the RRC resume message with the indication to release the first TA report configuration, the UE 102 transitions 840 to the connected state, and transmits 842B a DL MPDU including only an RRC resume complete message (e.g., RRCResumeComplete message) to the DU 174. Unlike in the event 842A, in this scenario, the UE 102 does not transmit the full TA value in the event 842B, since the UE 102 has discarded the first TA report configuration. The DU 174 in turn transmits 844 a DU-to-CU message (e.g., UL RRC Message Transfer message) forwarding the RRC resume complete message to the CU 174.

FIG. 8C is a messaging diagram of a scenario 800C that is similar to the scenario 800A illustrated in FIG. 8A. The differences between FIGS. 8A and 8C are discussed below. After the UE 102 in the inactive state determines 805 to resume the active state (i.e., to initiate an RRC connection resume procedure to transmit UL data, respond to a paging message received from the DU 174, or perform the RNAU), the UE 102 determines 879C that the difference between the full TA value currently applied by the UE (i.e., the second full TA value) and the first full TA value reported at event 818 (shown in FIG. 8A) is smaller than the value X_{offset} configured in the first TA report configuration (i.e., does not fulfill the threshold criterion). Therefore, unlike in scenario 800A, the UE determines to not transmit the second full TA value to the BS during the RRC connection resume procedure. In view of this determination, the UE 102 initiates 828C a Random Access (RA) procedure with the DU 174 and selects a RA preambles group by excluding the size of a TA Report MAC CE. In order to initiate the RA procedure, the UE 102 transmits an RA preamble belonging to the selected RA preambles group to the DU 174. In case of the four-step RA procedure, the DU 174 transmits an RA response to the UE 102 in response to the RA preamble, where the RA response includes an UL grant that is used by the UE 102 to transmit 830C an UL MAC PDU (MPDU) including only an RRC resume request message (e.g., an RRCResumeRequest message). In case of the two-step RA procedure, the UE 102 transmits 830C the MPDU including only an RRC resume request message using an UL grant indicated in the system information broadcast by the DU 174.

Upon receiving 830C the UL MPDU including only the RRC resume request message, the DU 174 transmits 832C a DU-to-CU message (e.g., Initial UL RRC Message Transfer message) forwarding the RRC resume request message to the CU 172. The DU-to-CU message further includes an IE/field ‘Request TA’ for retrieving UE's pre-inactive-state TA information preserved in the CU, that is, to request the first full TA value and/or the first differential k_offset value of the UE 102 from the CU 174. In response to the DU-to-CU message, the CU 172 transmits 836C a CU-to-DU message including an RRC message (e.g., RRCResume message), the first full TA value of UE 102, and/or the first differential k_offset value of the UE 102, to the DU 174. The message may set up a new TA report configuration for the UE 102 when including a TA report configuration.

Upon receiving the CU-to-DU message in event 836C, the DU 174 transmits 834C a DL MPDU including a Contention Resolution ID MAC CE to the UE 102 for contention resolution, and then transmits 838C the RRC resume message to the UE 102. The DU 174 may include a Differential Koffset MAC CE conveying a second differential k_offset value of the UE 102, in the DL MPDU transmitted at event 834C. Alternatively, the DU 174 may transmit the Differential Koffset MAC CE in the message transmitted at event 838C. The DU may transmit 834C a DL MPDU including the Contention Resolution ID MAC CE, the Differential Koffset MAC CE, and the RRC resume message to the UE 102. The DU 174 may determine the second differential k_offset value of the UE 102 based on the first differential k_offset value received in the event 836C. Alternatively, the DU 174 may determine the second differential k_offset value of the UE 102 based on the first full TA value received in the event 836C and the cell-specific k_offset value.

FIG. 8D is a messaging diagram of a scenario 800D similar to the scenario 800C illustrated in FIG. 8C. The differences between FIGS. 8D and 8C are discussed below. In scenario 800D, after transmitting 832C a DU-to-CU message including the RRC resume request message to the CU 172, the DU 174 receives 836C a CU-to-DU message including an RRC resume message that releases the previous TA report configuration (i.e., includes a SetupRelease {TAR-Config} type with the choice ‘release’). In turn, the DU 174 forwards 838D the RRC resume message to the UE 102.

Upon receiving the RRC resume message, the UE 102 transitions 840 to the connected state, and transmits 842B a DL MPDU including only an RRC resume complete message (e.g., RRCResumeComplete message) to the DU 174. Compared to the event 842A, the UE 102 in this scenario does not transmit a full TA value in the event 842B, because the UE 102 has discarded the TA report configuration. The DU 174 in turn transmits 844 a DU-to-CU message (e.g., UL RRC Message Transfer message) forwarding the RRC resume complete message to the CU 174.

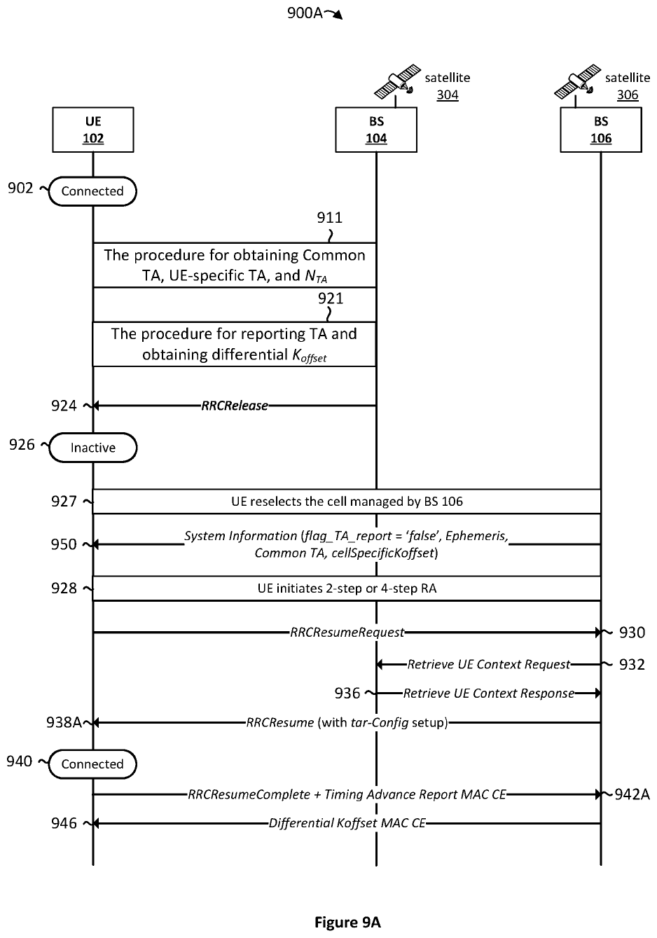

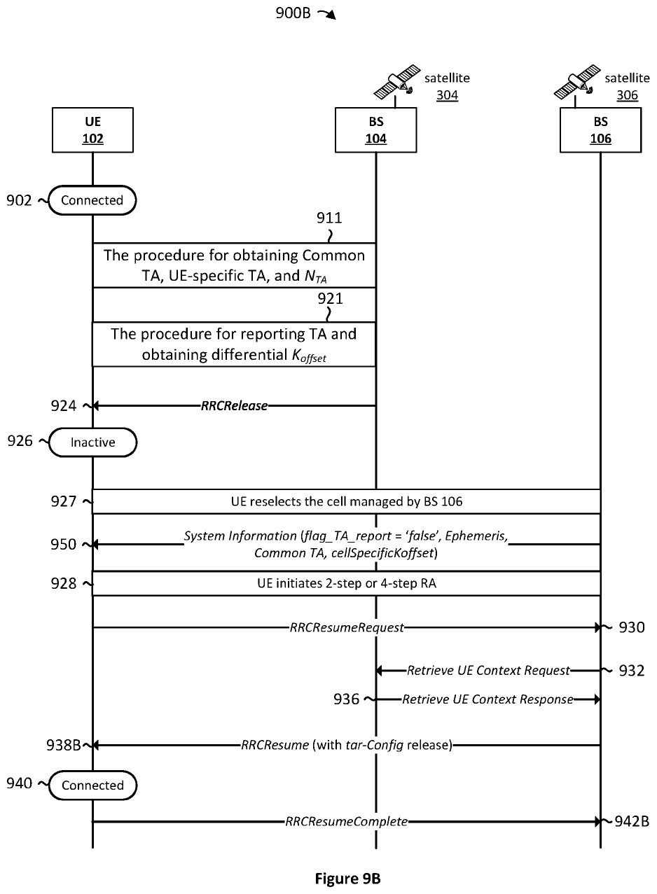

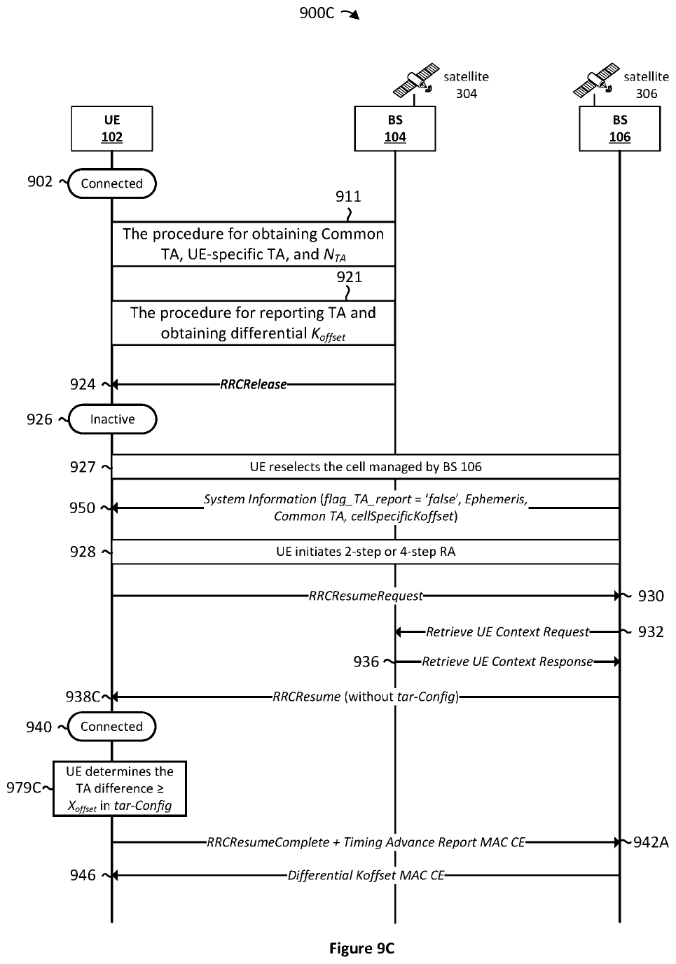

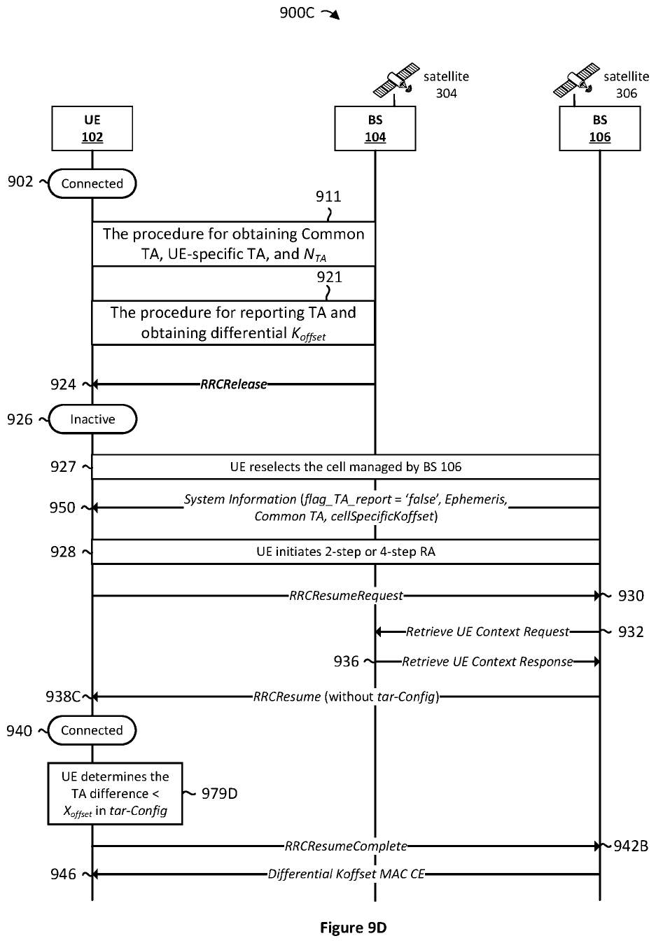

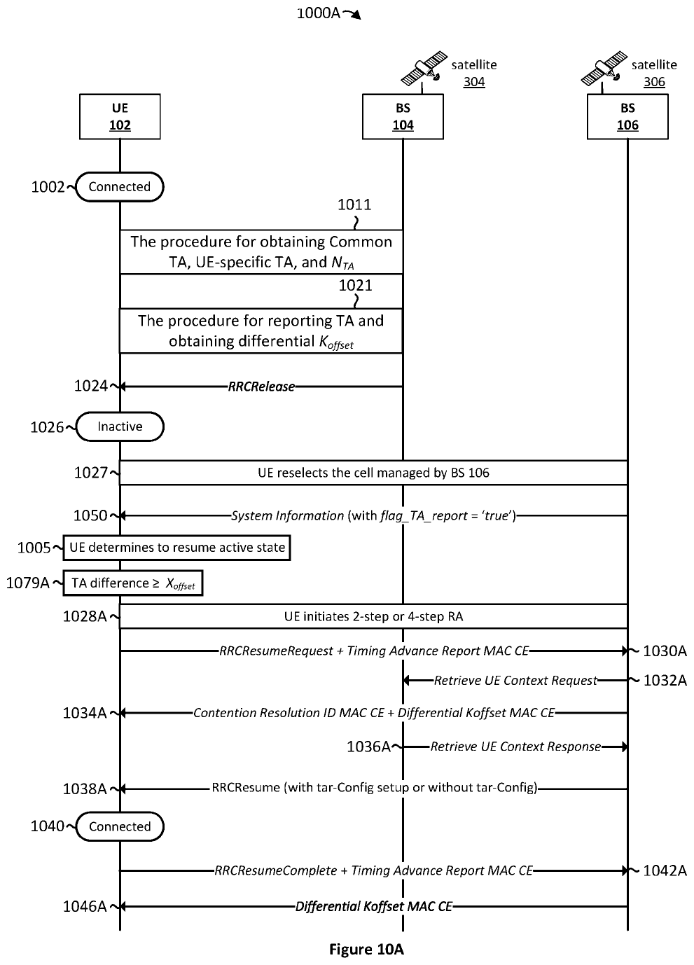

FIG. 9A is a messaging diagram of a scenario 900A in which the UE 102 is configured to report TA before entering an inactive state while in an initial cell (i.e., communicating with a base station 104 using satellite 304) moves to a new cell (i.e., communicating with a base station 104 using satellite 304). In this scenario 900A, the new cell does not broadcast a positive indication in the system information that requests UEs to report TA upon establishing/re-establishing/resuming the RRC connection with the new cell. The UE 102 initially operates 902 in the connected state and connects to the BS 104 via the service link for a first cell provided by the satellite 304. The UE 102 and base station 104 then perform a procedure 911 for obtaining common TA, UE-specific TA, and N_{TA}, and a procedure 921 for reporting TA and obtaining differential k_offsett (i.e., N_{TA}). Procedures 911 and 921 are similar to procedures 811 and 821 in FIG. 8A with BS 104 not necessarily a distributed base station. For example, in the procedure 921, the UE 102 receives a first TA report configuration from the BS 104 in an RRC reconfiguration message, transmits a first full TA value to the BS 104, and receives a first differential k_offset value from the BS 104. After performing the procedures 911 and 921, the UE 102 receives 924 an RRC release message from the BS 104 and transitions to the inactive state in response to this RRC release message. At a later time, the UE 102 selects or reselects and camps 927 on a second cell (e.g., cell 126 in FIG. 1A) supported by the BS 106 via satellite 306. The BS 106 broadcasts 950 system information that does not include a positive indication for the UEs to report TA upon establishing/re-establishing/resuming the RRC connection while camped on the second cell (i.e., flag_TA_report is not present or indicates a ‘false’ value). The UE 102 camped on the second cell determines to initiate resuming an active state via an RRC resume procedure with the BS 106 in order to transmit UL data, to respond to a paging message received from the BS 106, or to perform a RAN notification area update. For initiating the RRC connection resume procedure, the UE 102 initiates 928 an RA procedure (e.g., a two-step RA or a four-step RA procedure) with the BS 106 and transmits 930 an RRC resume request message to the BS 106. In this scenario, the UE 102 determines not to report a second full TA value to the BS 106 during the RRC connection resume procedure because the system information for the new cell (satellite 306, BS 106) does not include a positive indication for reporting TA upon performing the RRC connection establishment/re-establishment/resume procedure with the new cell. The UE 102 may release the first TA report configuration received from the BS 104 in response to selecting, reselecting or camping on the second cell, or initiating the RRC connection resume procedure on the second cell. Thus, the UE 102 transmits 930 an UL MAC PDU including the RRC resume request message to the BS 106, without including a TA Report MAC CE. In response to receiving the RRC resume request, the BS 106 (or a CU of the BS 106) transmits 932 a Retrieve UE Context Request message to the BS 104 (or to a CU of the BS 104). The BS 106 then receives 936 a Retrieve UE Context Response message from the BS 104 (or from the CU of the BS 104). The BS 106 may include an IE/field ‘Request TA’ in the Retrieve UE Context Request message, for requesting the first full TA value, the first different k_offset value, and/or the first TA report configuration of the UE 102. The BS 104 may include the first full TA value, the first differential k_offset value, and/or the first TA report configuration in the Retrieve UE Context Response message, as the response to the IE/field ‘Request TA’ included in the Retrieve UE Context Request message. The BS 104 may include the first full TA value, the first differential k_offset value, and/or the first TA report configuration in the Retrieve UE Context Response message, regardless of the content in the Retrieve UE Context Request message. The BS 106 may release the first TA report configuration. The BS 104 may refrain from including the first TA report configuration in the Retrieve UE Context Response message and the BS 104 may release the first TA report configuration after transmitting the Retrieve UE Context Response message.

After receiving the Retrieve UE Context Response message, the BS 106 transmits 938A an RRC resume message setting up a new (i.e., a second) TA report configuration (e.g., tar-Config) for the UE 102. The second TA report configuration can be similar to or different from the first TA report configuration. The BS 106 may generate the second TA report configuration based on the first TA report configuration or may generate the second TA report configuration irrespective of the first TA report configuration. In response to the RRC resume message, the UE 102 transitions 940 to the connected (i.e., active) state and transmits 942A an RRC resume complete message to the BS 106. The UE 102 may generate a TA Report MAC CE including a second full TA value of the UE 102 in response to the second TA report configuration. The UE 102 may transmit 942A an UL MPDU including the RRC resume complete message and the TA Report MAC CE to the BS 106 or may transmit an UL MPDU including the TA Report MAC CE to the BS 106 after transmitting the RRC resume complete message. After receiving the TA Report MAC CE from the UE 102, the BS 106 determines a second differential k_offset value for the UE 102 and then transmits 946 a DL MPDU including the Differential Koffset MAC CE including the second differential k_offset value to the UE 102.

FIG. 9B is a messaging diagram of a scenario 900B similar to the scenario 900A illustrated in FIG. 9A. The differences between FIGS. 9A and 9B are discussed below. After receiving 936 the Retrieve UE Context Response message, the BS 106 determines not to acquire TA information from the UE. In view of this determination, the BS 106 releases the first TA report configuration of the UE 102 (i.e., includes a SetupRelease {TAR-Config} type with the choice ‘release’) in the RRC resume message. The BS 106 then transmits 938B the RRC resume message to the UE 102. In response to receiving the RRC resume message releasing the TA report configuration, the UE 102 refrains from reporting TA information (e.g., a second full TA value) to the BS 106. If the UE 102 has released the first TA report configuration when selecting, reselecting or camping on the second cell, or when initiating an RRC connection resume procedure on the second cell, the BS 106 may omit the release indication in the RRC resume message.

FIG. 9C is a messaging diagram of a scenario 900C similar to the scenario 900A illustrated in FIG. 9A. The differences between FIGS. 9A and 9C are discussed below. In the scenario 900C, the UE 102 retains the first TA report configuration in response to selecting, reselecting, or camping on the second cell, or initiating the RRC connection resume procedure on the second cell. In this scenario, the BS 104 includes 936 the first TA report configuration in the Retrieve UE Context Response message, and the BS 106 determines to keep the first TA report configuration for the UE 102. Therefore, after receiving the Retrieve UE Context Response message, the BS 106 transmits 938C an RRC resume message without including any TA report configuration (i.e., without including tar-Config) to the UE 102. After receiving (e.g., in response to) the RRC resume message excluding a TA report configuration, the UE 102 transitions 940 to the connected state, continues to use the first TA report configuration, and determines 979C whether the difference between the first full TA value reported in the procedure 921 and the full TA value currently applied by the UE 102 (i.e., the second full TA value) is equal to or larger than the threshold value X_{offset} included in the first TA report configuration. In this scenario, because the TA difference fulfills the threshold criterion by being equal to or larger than (or alternatively, just larger than) the threshold value X_{offset}, the UE 102 determines to report the second full TA value to the BS 106. The UE 102 transmits 942A an UL MPDU including an RRC resume complete message and a TA Report MAC CE to the BS 106 (the TA Report MAC CE including the second full TA value of the UE 102). The UE 102 may transmit an UL MPDU including the TA Report MAC CE to the BS 106 after transmitting the RRC resume complete message. The BS 106 then (after receiving the TA Report MAC CE from the UE 102) determines a second differential k_offset value for the UE 102 and transmits 946 a DL MPDU including a Differential Koffset MAC CE including the second differential k_offset value to the UE 102.

FIG. 9D is a messaging diagram of a scenario 900D similar to the scenario 900C illustrated in FIG. 9C. The differences between FIGS. 9C and 9D are discussed below. In the scenario 900D, the UE 102 determines 979D that the TA difference is smaller than the threshold value X_{offset}, and therefore the UE determines not to report the second full TA value to the BS 106. In view of this determination, the UE 102 transmits 942B an UL MPDU including only an RRC resume complete message the BS 106. The BS 106, after receiving the RRC resume complete message, determines a second differential k_offset value for the UE 102 based on the first differential k_offset value of the UE 102 received in the event 936, and then transmits 946 a DL MPDU including a Differential Koffset MAC CE including the second differential k_offset value to the UE 102.

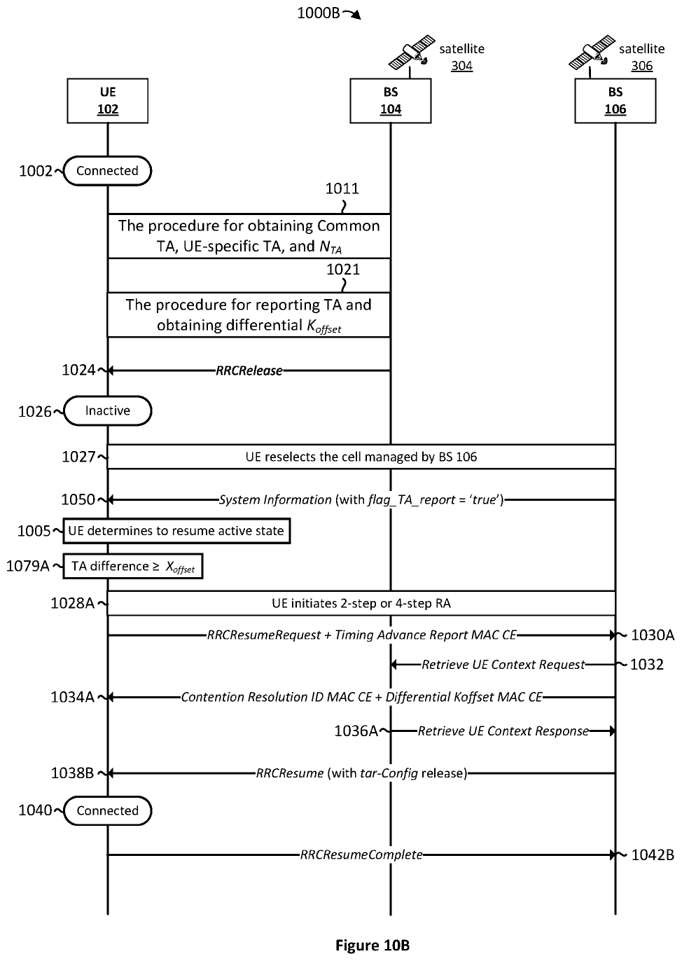

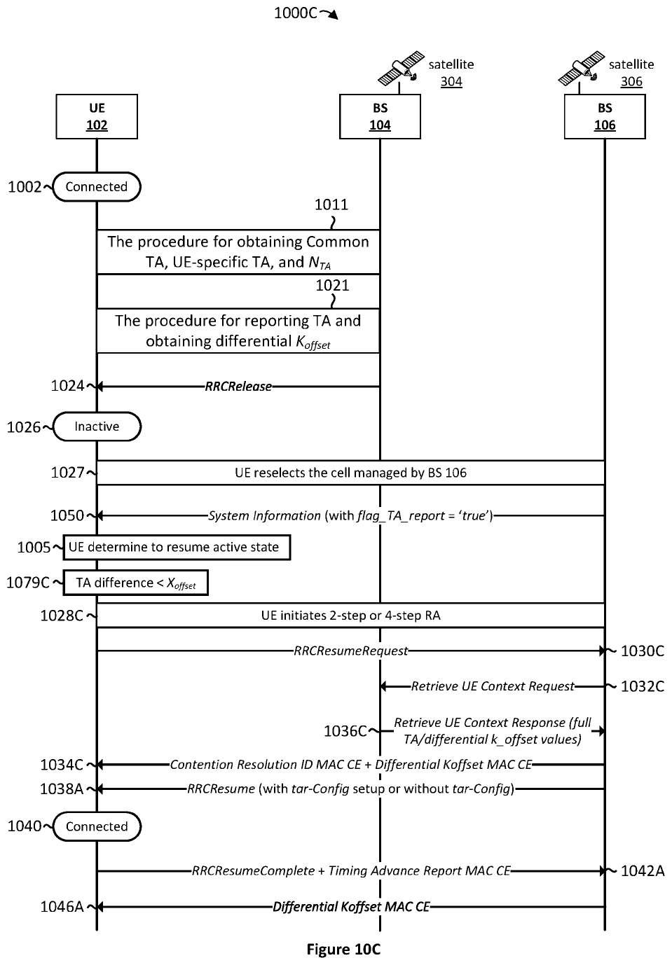

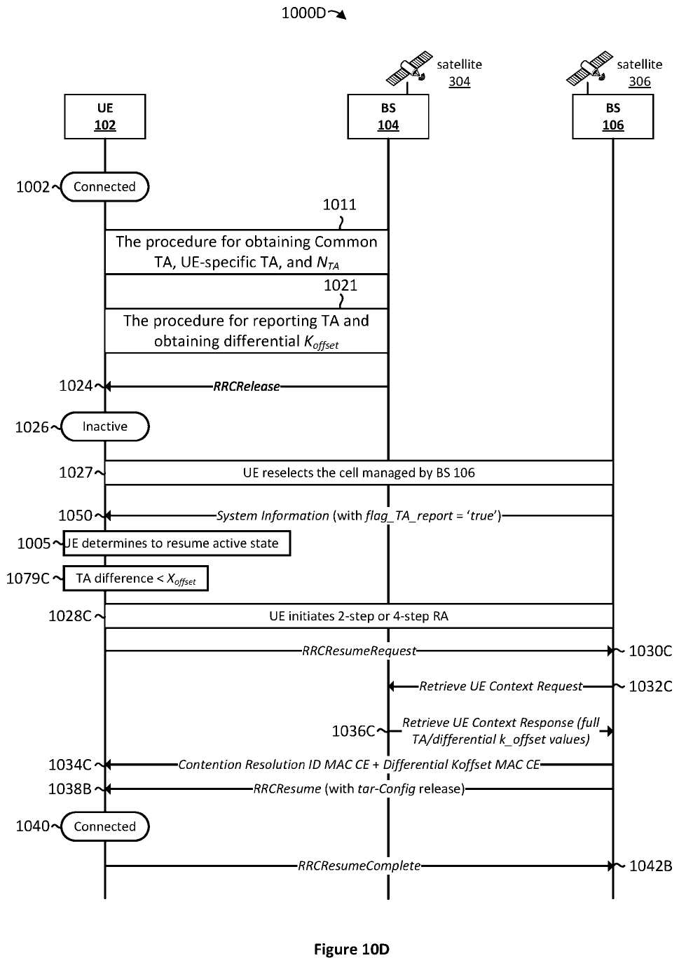

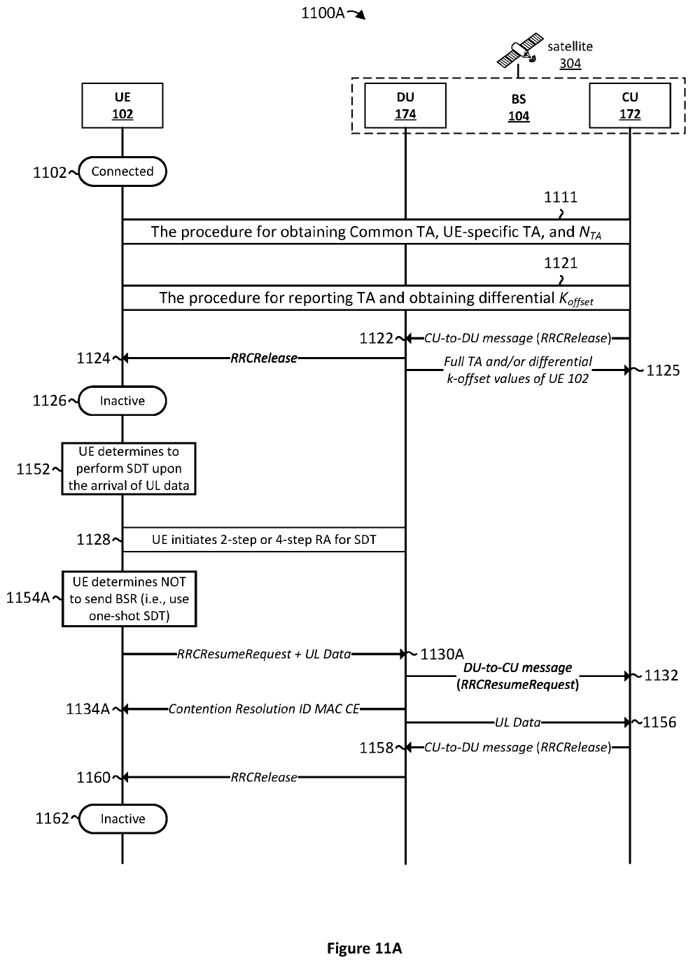

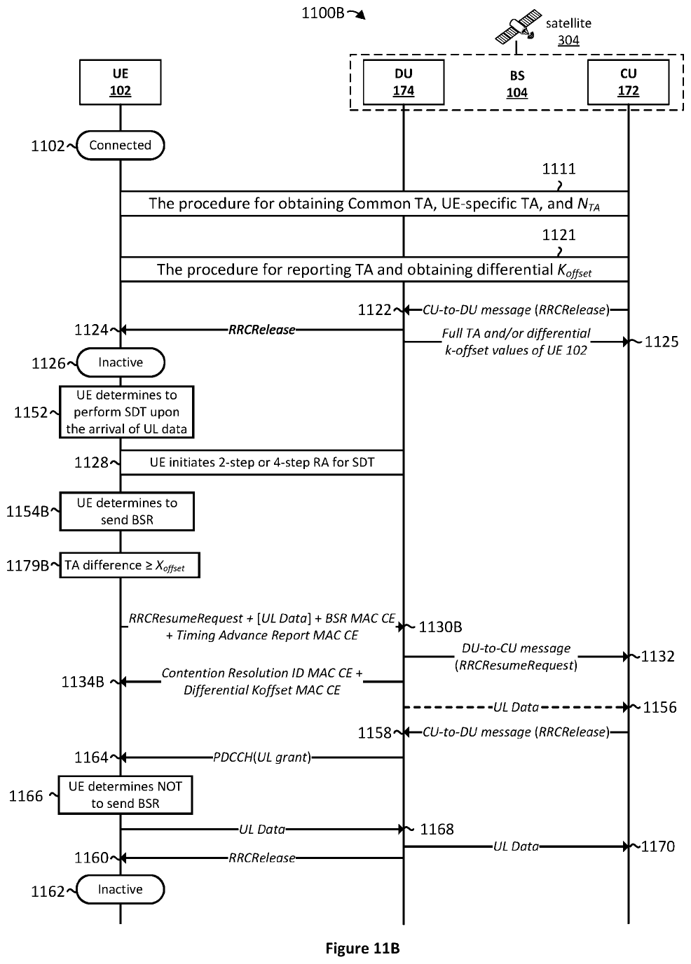

FIG. 10A is a messaging diagram 1000A of a scenario in which UE 102 previously configured with a TA report configuration moves to a new cell, where the new cell broadcasts a positive indication in the system information for UEs to report TA information upon establishing/re-establishing/resuming the RRC connection with the new cell. In the scenario 1000A, the UE 102 initially operates 1002 in the connected (active) state being connected in a first cell to the BS 104 via the service link provided by the satellite 304. The UE 102 and base station 104 then perform a procedure 1011 (similar to procedure 811) for obtaining common TA, UE-specific TA, and N_{TA}, and a procedure 1021 (similar to procedure 821) for reporting TA and obtaining differential k_offset. In the procedure 1021, the UE 102 receives a first TA report configuration from the BS 104 in an RRC reconfiguration message, transmits a first full TA value to the BS 104, and receives a first differential k_offset value from the BS 104. After performing the procedures 1011 and 1021, the UE 102 receives 1024 an RRC release message from the BS 104 and transitions 1026 to the inactive state in response to the RRC release message. At a later time, the UE 102 selects or reselects and camps 1027 on a second cell (e.g., cell 126 in FIG. 1A) supported by the BS 106 via satellite 306. The BS 106 broadcasts 1050 system information that includes a positive indication for the UEs to report TA upon establishing/re-establishing/resuming the RRC connection with the second cell (i.e., flag_TA_report is present and indicates a ‘true’ value). The UE 102 camped on the second cell determines 1005 to initiate an RRC connection resume procedure with the BS 106, in order to transmit UL data, respond to a paging message received from the BS 106, or perform a RAN notification area update. After this determination, the UE 102 examines the difference between the first full TA value reported in the procedure 1021 and the full TA value currently applied by the UE 102 (i.e., the second full TA value), and determines 1079A that the difference is equal to or larger than the threshold value X_{offset} included in the first TA report configuration. Then further to events 1005 and 1079A, the UE 102 initiates 1028A an RA procedure (e.g., a two-step RA or a four-step RA procedure) and selects a RA preambles group by taking into account the size of the TA Report MAC. The UE 102 then transmits 1030A an UL MPDU including an RRC resume request message and a TA Report MAC CE containing the second full TA value to the BS 106 using the UL resource obtained by initiating the RA procedure. In response to receiving the RRC resume request message and the TA Report MAC CE, the BS 106 (or a CU of the BS 106) transmits 1032A a Retrieve UE Context Request message to the BS 104 (or to a CU of the BS 104), and also transmits 1034A a DL MPDU including a Contention Resolution ID MAC CE to the UE 102 for contention resolution. The BS 106 (or a CU of the BS 106) may include, in the DL MPDU at event 1034A, a Differential Koffset MAC CE including a second differential k_offset value. Alternatively, the BS 106 (or a CU of the BS 106) may transmit the Differential Koffset MAC CE at event 1038A. The BS 106 (or a CU of the BS 106) may determine the second differential k_offset value based on the second full TA value reported by the UE 102 and the cell-specific k_offset value of the cell currently selected by the UE 102 (e.g., cell 126).

In response to the RRC resume request message, the BS 104 (or a CU of the BS 104) transmits 1036A a Retrieve UE Context Response message to the BS 106. The BS 104 may include the first full TA value, the first differential k_offset value, and/or the first TA report configuration in the Retrieve UE Context Response message. The BS 106 may release the first TA report configuration. The BS 104 may refrain from including the first TA report configuration in the Retrieve UE Context Response message. The BS 104 may then release the first TA report configuration in response to transmitting the Retrieve UE Context Response message.

After receiving the Retrieve UE Context Response message, the BS 106 transmits 1038A an RRC resume message setting up a new (i.e., a second) TA report configuration (e.g., tar-Config) for the UE 102. The second TA report configuration may be similar to or different from the first TA report configuration. That is, the BS 106 may generate the second TA report configuration based on the first TA report configuration or may generate the second TA report configuration irrespective of the first TA report configuration. In some implementations, the BS does not include a TA report configuration in the RRC resume message. In response to the RRC resume message, the UE 102 transitions 1040 to the connected (active) state and transmits 1042A an RRC resume complete message to the BS 106. The UE 102 may generate a TA Report MAC CE including a third full TA value of the UE 102 in response to the RRC resume message including the second TA report configuration or without including a TA report configuration. The UE 102 may transmit 1042A an UL MPDU including the RRC resume complete message and the TA Report MAC CE to the BS 106 or may transmit an UL MPDU including the TA Report MAC CE to the BS 106 after transmitting the RRC resume complete message. After receiving the TA Report MAC CE from the UE 102, the BS 106 determines a third differential k_offset value for the UE 102 and then transmits 1046A a DL MPDU including the Differential Koffset MAC CE containing the third differential k_offset value to the UE 102.

In response to the event 1038A, the UE 102 may transmit 1042A a DL MPDU without including a third full TA value to the BS 106 when the UE 102 has reported already the second full TA value in the same RRC resume procedure and the difference between the third full TA and the second full TA is less than the value X_{offset} configured in the TA report configuration.

FIG. 10B is a messaging diagram of a scenario 1000B similar to the scenario 1000A illustrated in FIG. 10A. The differences between FIGS. 10A and 10B are discussed below. In the scenario 1000B, after receiving 1036A the Retrieve UE Context Response message, the BS 106 (or a CU of the BS 106) transmits 1038B to the UE 102 an RRC resume message that releases the first TA report configuration (i.e., includes a SetupRelease {TAR-Config} type with the choice ‘release’).

Upon receiving the RRC resume message, the UE 102 transitions 1040 to the connected (active) state and transmits 1042B a DL MPDU including only an RRC resume complete message (e.g., RRCResumeComplete message) to the BS 106. Unlike in the event 1042A, the UE 102 in this scenario does not transmit a full TA value in the event 1042B, because the UE 102 has discarded the TA report configuration.

FIG. 10C is a messaging diagram of a scenario 1000C similar to the scenario 1000A illustrated in FIG. 10A. The differences between FIGS. 10A and 10C are discussed below. After the UE 102 in the inactive state determines 1005 to resume the active state (in order to to transmit UL data, respond to a paging message received from the BS 106, or perform the RNAU), the UE 102 determines 1079C that the difference between the full TA value currently applied by the UE (i.e., the second full TA value) and the first full TA value reported in the procedure 1021 is smaller than the value X_{offset} configured in the TA report configuration. The UE 102 then does not transmit the second full TA value to the BS during the RRC connection resume procedure. The UE 102 initiates 1028C a Random Access (RA) procedure with the BS 106 and selects a RA preambles group excluding the size of the TA Report MAC CE. The UE 102 initiates the RA procedure by transmitting an RA preamble of the selected RA preambles group to the BS 106. In case of the four-step RA procedure, the BS 106 transmits an RA response to the RA preamble, where the RA response includes an UL grant that is used by the UE 102 to transmit 1030C an UL MAC PDU (MPDU) including only an RRC resume request message (e.g., RRCResumeRequest message). In case of the two-step RA procedure, the UE 102 transmits 1030C the MPDU including only an RRC resume request message using an UL grant indicated in system information broadcast by the DU 174.

Upon receiving the UL MPDU including only the RRC resume request message, the BS 106 transmits 1032C a Retrieve UE Context Request message to the BS 104. The Retrieve UE Context Request message further includes an IE/field ‘Request TA’ that is used to request the BS 104 to provide the first (pre-inactive-state) full TA value and/or the first differential k_offset value of the UE 102. In response to the Retrieve UE Context Request message, the BS 104 transmits 1036C a Retrieve UE Context Response message including the first TA full value of UE 102, the first differential k_offset value, and/or the first TA report configuration of the UE 102, to the BS 106. After receiving the Retrieve UE Context Response message, the BS 106 determines the second differential k_offset value for the UE 102 based on the first full TA value of the UE 102 and the cell-specific k_offset value of the cell currently selected by the UE 102 (e.g., cell 126). Alternatively, the BS 106 determines the second differential k_offset value for the UE 102 based on the first (pre-inactive-state) differential k_offset value of the UE 102. The BS 106 then transmits 1034C a DL MPDU including a Contention Resolution ID MAC CE for contention resolution. The BS 106 may include a Differential Koffset MAC CE including the second differential k_offset value of the UE 102 in the DL MPDU at event 1034C. Alternatively, the BS 106 may transmit the Differential Koffset MAC CE at event 1038A, where an RRC resume message including a second TA report configuration or including no TA report configuration is to be transmitted to the UE 102, in response to the RRC resume request message.

FIG. 10D is a messaging diagram of a scenario 1000D similar to the scenario 1000C illustrated in FIG. 10C. The differences between FIGS. 10D and 10C are discussed below. After receiving 1036C a Retrieve UE Context Response message from the BS 104, the BS 106 transmits 1038C to the UE 102 an RRC resume message that releases the previous TA report configuration (i.e., includes a SetupRelease {TAR-Config} type with the choice ‘release’).

Upon receiving the RRC resume message, the UE 102 transitions 1040 to the connected (active) state and transmits 1042B an UL MPDU including only an RRC resume complete message (e.g., RRCResumeComplete message) to the BS 106. Unlike in the event 1042A, in this scenario the UE 102 does not transmit a full TA value in the event 1042B, because the UE 102 has discarded the first TA report configuration.

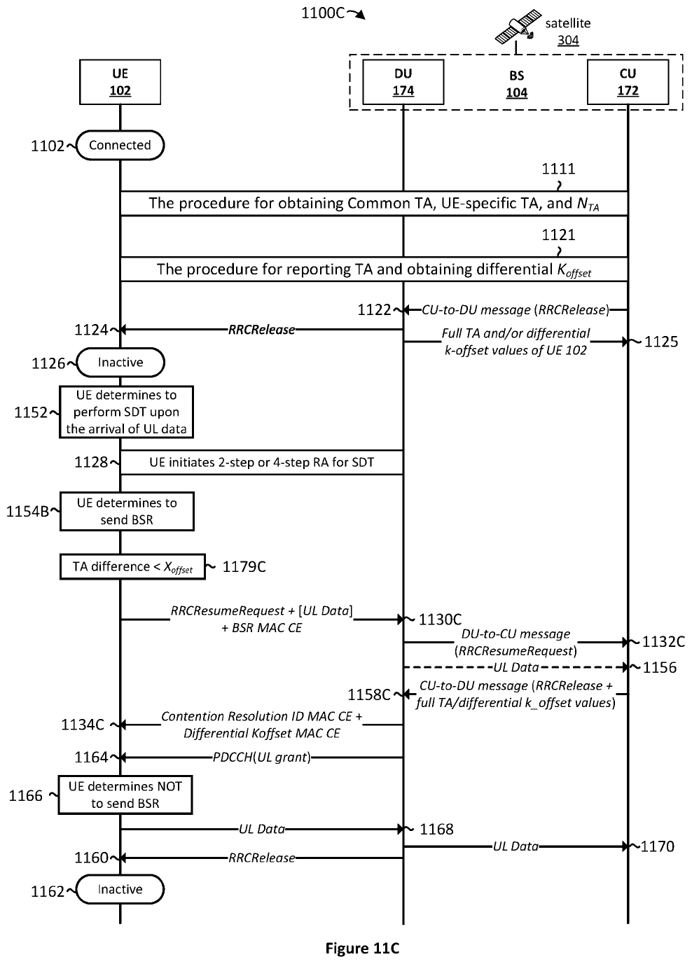

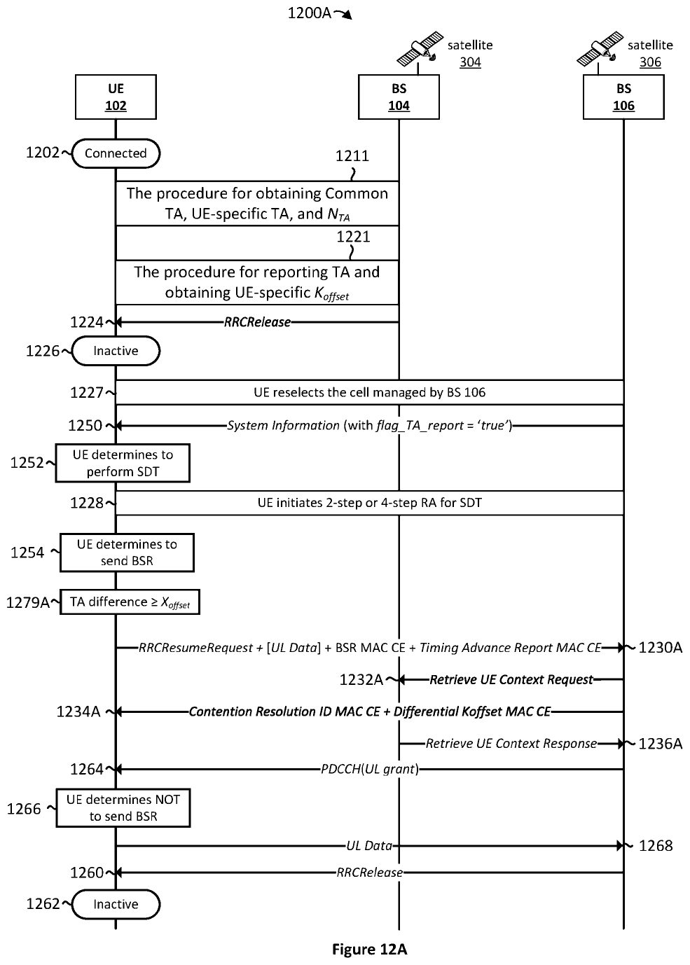

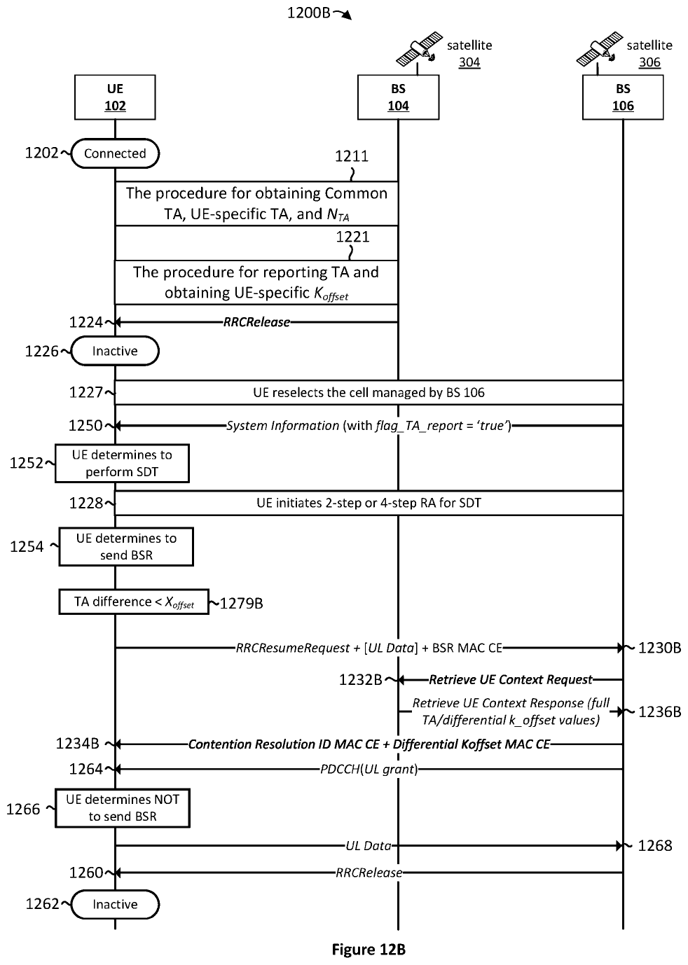

FIG. 11A is a messaging diagram of a scenario 1100A in which a UE configured with the TA report configuration performs a Small Data Transmission, SDT, with the network with a one-shot data transmission. In the scenario 1100A, the UE 102 initially operates 1102 in the connected state communicating with the BS 104 via the service link provided via the satellite 304 for a first cell. The UE 102 and base station 104 then perform a procedure 1111 (similar to 811) for obtaining a common TA, a UE-specific TA, and an N_{TA}, and a procedure 1021 (similar to 821) for reporting TA and obtaining a differential k_offset value. In the procedure 1121, the UE 102 receives a first TA report configuration from the BS 104 in an RRC reconfiguration message, transmits a first full TA value to the BS 104. The UE 102 then receives a first differential k_offset value from the BS 104. After performing the procedures 1111 and 1121, the CU 172 determines data inactivity of the UE 102 (i.e., the UE 102 in the connected state has no data activity with the BS 104). In response to the determination, the CU 172 sends 1122 a CU-to-DU message (e.g., a UE Context Release Command message) that includes an RRC release message (e.g., RRCRelease message) to trigger the UE 102 to transition to the inactive state. The RRC release message may include a SuspendConfig Information Element (IE) configuring the UE 102 to transition to the inactive state. In this case, the RRC release message further includes an SDT configuration that allows the UE 102 to transmit user data in the inactive data. The DU 174 then transmits 1124 the RRC release message to the UE 102. The DU 174 may transmit 1125 a DU-to-CU message including the first full TA value and/or the first differential k-offset value of the UE 102 to the CU 172.

At a later time, while in the inactive state, the UE 102 determines 1152 to perform an SDT procedure due to the arrival of the UL traffic belonging to the SDT DRBs/SRBs. In view of this determination, the UE 102 initiates 1128 a 2-step or 4-step Random Access (RA) procedure by sending the RA preamble allocated for the SDT purpose to the DU 174 of the BS 104. Upon receiving the UL grant/resource in response to the RA preamble transmission, the UE 102 examines whether the UL grant/resource is large enough to accommodate all the pending SDT data (i.e., the pending UL data belonging to the SDT DRBs/SRBs) plus an RRC Resume Request message. In this scenario, because the UL grant/resource is large enough to accommodate all the pending SDT data and an RRC Resume Request, the UE 102 determines to transmit all the pending SDT data in one-shot and therefore determines 1154A not to send the Buffer Status Report (BSR) MAC CE in the UL grant/resource. Following the determination, the UE 102 transmits 1130A the MPDU including the RRC Resume Request message and the pending SDT data to the DU 174, without including a BSR MAC CE nor a TA Report MAC CE.

Upon receiving the UL MPDU including the RRC resume request message and the UL data, the DU 174 transmits 1132 a DU-to-CU message (e.g., Initial UL RRC Message Transfer message) including the RRC resume request message to the CU 172 and then transmits 1156 the UL data to the CU 172. The DU 174 also transmits 1134A a DL MPDU including a Contention Resolution ID MAC CE to the UE 102 for contention resolution. In response to the RRC resume request message, the CU 172 retrieves the context of the UE 102 and transmits 1158 a CU-to-DU message including an RRC release message (e.g., RRCRelease message) to the DU 174, where the RRC release message may further include a SuspendConfig IE and an SDT configuration. The DU 174 in turn transmits 1160 the RRC release message to the UE 102. Although in this example the DU 174 receives a CU-to-DU message including an RRC release message after transmitting the Contention Resolution ID MAC CE to the UE 102, it is possible that the DU 174 receives the CU-to-DU message before transmitting the Contention Resolution ID MAC CE to the UE 102. In such cases (i.e., 1158 occurs earlier than 1134A), the DU 174 may transmit the Contention Resolution ID MAC CE together with the RRC release message to the UE 102 (i.e., 1134A and 1160 can be merged). The UE 102 then transitions 1162 to the inactive state upon receiving the RRC release message.

FIG. 11B is a messaging diagram of a scenario 1100B similar to the scenario 1100A illustrated in FIG. 11A. The differences between FIGS. 11A and 11B are discussed below. As in scenario 1100A in scenario 1100B, upon receiving the UL grant/resource in response to the RA preamble transmission in the event 1128, the UE 102 examines whether the UL grant/resource is large enough to accommodate all the pending SDT data (i.e., the pending UL data belonging to the SDT DRBs/SRBs) plus an RRC resume request message. In scenario 1100B, because the UL grant/resource is not large enough to accommodate all the pending SDT data and an RRC resume request, the UE 102 determines 1154B to segment the pending SDT data and to send a BSR MAC CE using the available UL grant/resource to inform the network regarding subsequent SDT data transmissions. The UE 102 then examines 1179B whether the difference between the full TA value currently applied by the UE (i.e., the second full TA value) and the first full TA value reported in the procedure 1121 is equal to or larger than the value X_{offset} configured in the first TA report configuration. In scenario 1100B, because the TA difference fulfills the threshold criterion by being equal to or larger than the threshold value X_{offset}, the UE 102 transmits 1130B an UL MPDU including an RRC resume request message, a BSR MAC CE, and a TA Report MAC CE containing the second full TA value to the DU 174. The UE 102 may further include a segment of the SDT data in the MPDU transmitted in the event 1130B if the UL grant/resource is able to accommodate the segment.

Upon receiving the UL MPDU in the event 1130B, the DU 174 (A) transmits 1132 a DU-to-CU message (e.g., Initial UL RRC Message Transfer message) including the RRC resume request message to the CU 172, (B) determines a second differential k_offset value for the UE 102 based on the received second full TA value of the UE 102, and (C) transmits 1134B a DL MPDU including a Contention Resolution ID MAC CE and a Differential Koffset MAC CE containing the second differential k_offset value to the UE 102. The DU 174 may also transmit 1156 the segment of the SDT data to the CU 172, if it has received the segment of the SDT data in the event 1130B.

In response to the RRCResumeRequest message, the CU 172 retrieves the context (e.g., first/pre-inactive-state TA information) of the UE 102 and transmits 1158 a CU-to-DU message including an RRCRelease message to the DU 174. The RRCRelease message may further include a SuspendConfig IE and an SDT configuration. Upon receiving the CU-to-DU message including the RRC release message, the DU 174 transmits 1164 to the UE 102 a PDCCH that includes an UL grant for the UE, to accommodate the subsequent data transmission indicated by receiving the BSR MAC CE in step 1130B. In response to receiving the UL grant, UE 102 reexamines whether the UL grant is large enough to accommodate all the pending SDT data. In this example, because the UL grant provided in step 1164 is large enough to accommodate all the pending SDT data, the UE 102 determines to transmit all the pending SDT data in one-shot and therefore determines 1166 not to send the BSR MAC CE in the UL grant. Following the determination, the UE 102 transmits 1168 an UL MPDU including only the UL data to the DU 174, without including a BSR MAC CE nor a TA Report MAC CE. Upon receiving the UL data, the DU 174 transmits 1170 the UL data to the CU 172, and then transmits 1160 the RRC release message to the UE 102. The UE 102 remains 1162 in the inactive state upon receiving the RRC release message.

FIG. 11C is a messaging diagram of a 1100C similar to the scenario 1100B illustrated in FIG. 11B. The differences between FIGS. 11C and 11B are discussed below. Similar to the scenario 1100B, in the scenario 1100C, the UE 102 determines 1154B to segment the pending SDT data and send a BSR MAC CE in the available UL grant/resource to inform the network regarding subsequent SDT data transmissions. The UE 102 then examines whether the difference between the full TA value currently applied by the UE (i.e., the second full TA value) and the first full TA value reported in the procedure 1121 is equal to or larger than the value X_{offset} configured in the first TA report configuration (i.e., fulfills the threshold criterion). Unlike in scenario 1100B, because 1179C the TA difference is smaller than the threshold value X_{offset}, the TA difference does not fulfill the threshold criterion and the UE transmits 1130C an UL MPDU including an RRC resume request message and a BSR MAC CE (i.e., without including a TA Report MAC CE) to the DU 174. The UE 102 may further include a segment of the SDT data in the MPDU transmitted in the event 1130C, if the UL grant/resource is able to accommodate such segment.

Upon receiving the UL MPDU in the event 1130C, the DU 174 transmits 1132C a DU-to-CU message (e.g., Initial UL RRC Message Transfer message) including the RRC resume request message, to the CU 172. The DU-to-CU message further includes an IE/field ‘Request TA’ that is used to request the first full TA value and/or the first differential k_offset value of the UE 102 from the CU 174.

In response to the DU-to-CU message, the CU 172 transmits 1158C a CU-to-DU message including an RRC release message (e.g., RRCRelease message), the first full TA value of UE 102, and/or the first differential k_offset value of the UE 102, to the DU 174, where the RRC release message may also include a SuspendConfig IE and an SDT configuration.

Upon receiving the CU-to-DU message in event 1158C, the DU 174 transmits 1134C a DL MPDU including a Contention Resolution ID MAC CE to the UE 102 for contention resolution, and then transmits 1164 to the UE 102 a PDCCH that provides an UL grant for the UE. The DU 174 may include, in the DL MPDU at event 1134C, a Differential Koffset MAC CE that conveys a second differential k_offset value of the UE 102, where the second differential k_offset value is determined based on the first differential k_offset value or the first full TA value received in the event 1158C.

FIG. 12A is a messaging diagram of a scenario 1200A in which the UE configured with a TA report configuration moves to a new cell and performs an SDT procedure with the new cell. In this scenario, the new cell broadcasting includes a positive indication in the system information for UEs to report TA information when establishing/re-establishing/resuming the RRC connection with the new cell. The UE 102 initially operates 1202 in the connected state and connects to the BS 104 via the service link provided by the satellite 304 for a first cell. The UE 102 and base station 104 then perform a procedure 1211 (similar to procedure 811) for obtaining common TA, UE-specific TA, and N_{TA}, and a procedure 1221 (similar to procedure 821) for reporting TA and obtaining differential k_offset. In the procedure 1221, the UE 102 receives a first TA report configuration from the BS 104 in an RRC reconfiguration message, transmits a first full TA value to the BS 104, and receives a first differential k_offset value from the BS 104. After performing the procedures 1211 and 1221, the UE 102 receives 1224 an RRC release message from the BS 104 and transitions 1226 to the inactive state in response to the RRC release message. The RRC release message in the event 1224 may further include a suspendConfig IE and an SDT configuration. At a later time, the UE 102 selects or reselects and camps 1227 on a second cell (e.g., cell 126 in FIG. 1A) supported by the BS 106 that broadcasts 1250 system information that includes a positive indication for UEs to report TA upon establishing/re-establishing/resuming the RRC connection with the second cell (i.e., flag_TA_report is present and indicates a ‘true’ value).

After camping on the second cell, the UE 102 determines 1252 to perform an SDT procedure due to the arrival of the UL traffic belonging to the SDT DRBs/SRBs. In view of this determination, the UE 102 initiates 1228 a 2-step or 4-step Random Access (RA) procedure by sending the RA preamble allocated for the SDT purpose, to the BS 106. Upon receiving an UL grant in response to the RA preamble transmission, the UE 102 determines whether the UL grant/resource is large enough to accommodate all the pending SDT data (i.e., the pending UL data belonging to the SDT DRBs/SRBs) plus an RRC resume request message. In this example, because the UL grant/resource is not large enough to accommodate all the pending SDT data plus an RRC Resume Request, the UE 102 determines 1254 to segment the pending SDT data and send a BSR MAC CE in the UL grant/resource to inform the network regarding subsequent SDT data transmissions. The UE 102 then examines whether the difference between the full TA value currently applied by the UE (i.e., the second full TA value) and the first full TA value reported in the procedure 1221 is equal to or larger than the value X_{offset} configured in the first TA report configuration. In this scenario, because 1279A the TA difference fulfills the threshold criterion by being equal to or larger than the threshold value X_{offset}, the UE transmits 1230A an UL MPDU including an RRC resume request message, a BSR MAC CE, and a TA Report MAC CE containing the second full TA value to the BS 106. The UE 102 may further include a segment of the SDT data in the MPDU transmitted in the event 1230A, if the UL grant/resource is able to accommodate such a segment.

Upon receiving the UL MPDU in the event 1230A, the BS 106 (A) transmits 1232A a Retrieve UE Context Request message to the BS 104, (B) determines a second differential k_offset value for the UE 102 based on the received second full TA value of the UE 102, and (C) transmits 1234A a DL MPDU including a Contention Resolution ID MAC CE and a Differential Koffset MAC CE containing the second differential k_offset value to the UE 102. In response to the Retrieve UE Context Request message, the BS 104 returns the context of the UE 102 by transmitting 1236A a Retrieve UE Context Response message that does not include UE's pre-inactive-state TA information.

Upon receiving the Retrieve UE Context Response message, the BS 106 transmits 1264 to the UE 102 a PDCCH that provides an UL grant for the UE, as the BS 106 has understood the UE 102 needs the subsequent data transmission upon receiving the BSR MAC CE in step 1230A. In response to receiving the UL grant, UE 102 reexamines whether the UL grant is large enough to accommodate all the pending SDT data. Because the UL grant provided in step 1264 is large enough to accommodate all the pending SDT data, the UE 102 determines 1266 to transmit all the pending SDT data in one-shot and therefore determines 1266 not to send the BSR MAC CE in the UL grant. Following the determination, the UE 102 transmits 1268 an UL MPDU including only the UL data to the BS 106, without including a BSR MAC CE nor a TA Report MAC CE. Upon receiving the UL data, the BS 106 transmits 1260 the RRC release message to the UE 102, where the RRC release message may further include a SuspendConfig IE and an SDT configuration. The UE 102 stays 1262 in the inactive state upon receiving the RRC release message.

FIG. 12B is a messaging diagram of a scenario 1200B similar to the scenario 1200A illustrated in FIG. 12A. The differences between FIGS. 12B and 12A are discussed below. Similar to scenario 1200A, in scenario 1200B, the UE 102 determines 1254 to segment the pending SDT data and sends a BSR MAC CE in the available UL grant/resource to inform the network regarding subsequent SDT data transmissions. Following the determination, the UE 102 examines whether the difference between the full TA value currently applied by the UE (i.e., the second full TA value) and the first full TA value reported in the procedure 1221 is equal to or larger than the value X_{offset} configured in the first TA report configuration. In this scenario, because 1279B the TA difference is smaller than the threshold value X_{offset} (i.e., does not fulfill the threshold criterion), the UE transmits 1230B an UL MPDU including an RRC resume request message and a BSR MAC CE (i.e., without including a TA Report MAC CE) to the BS 106. The UE 102 may further include a segment of the SDT data in the MPDU transmitted in the event 1230B, if the UL grant/resource is able to accommodate the segment.

Upon receiving the UL MPDU in the event 1230B, the BS 106 transmits 1232B a Retrieve UE Context Request message to the BS 104. The Retrieve UE Context Request message further includes an IE/field ‘Request TA’ that is used to request the first full TA value and/or the first differential k_offset value of the UE 102 from the BS 104.

In response to the Retrieve UE Context Request message, the BS 104 transmits 1236B a Retrieve UE Context Response message including the first full TA value of UE 102 and/or the first differential k_offset value of the UE 102, to the BS 106. Upon receiving the Retrieve UE Context Response message in event 1236B, the BS 106 transmits 1234B a DL MPDU including a Contention Resolution ID MAC CE to the UE 102 for contention resolution, and then transmits 1264 to the UE 102 a PDCCH that schedules an UL grant for the UE. In some implementations, the BS 106 can include, in the DL MPDU at event 1234B, a Differential Koffset MAC CE including a second differential k_offset value of the UE 102, where the second differential k_offset value is determined based on the first (pre-inactive-state) full TA value received in the event 1236B and the cell-specific k_offset value of the cell selected by the UE 102 (e.g., the cell 126). In some implementations, the second different k_offset value transmitted at event 1234B is determined by the BS 106, based on the first (pre-inactive-state) differential k_offset value of the UE 102 received at event 1236B.

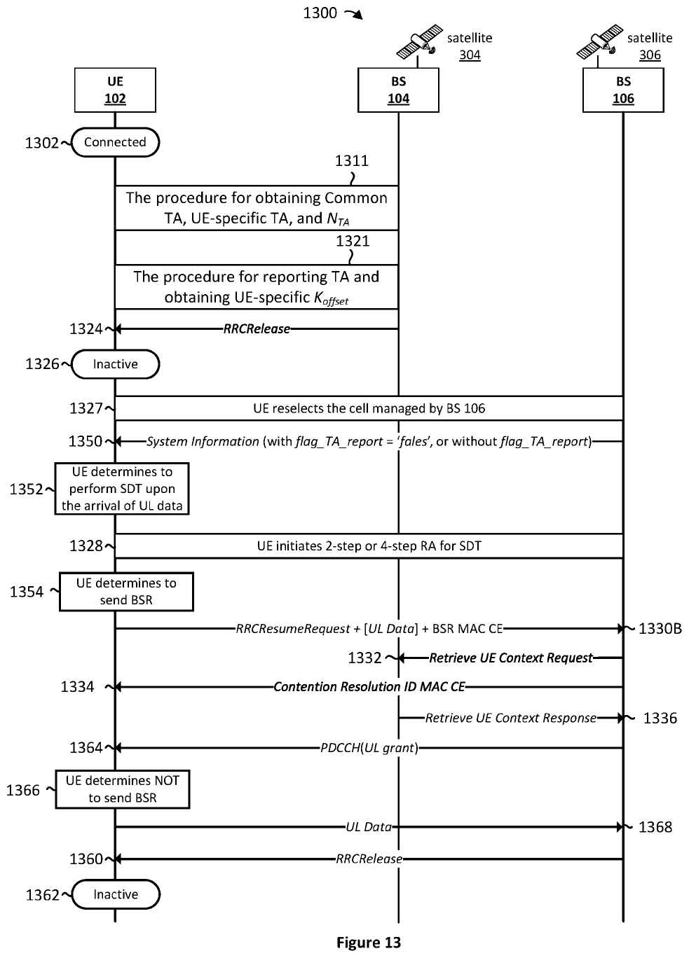

FIG. 13 is a messaging diagram of a scenario 1300 similar to the scenario 1200A illustrated in FIG. 12A. The differences between FIGS. 13 and 12A are discussed below. Similar to 1227, in the scenario 1300, the UE 102 selects or reselects and camps 1327 on a second cell (e.g., cell 126 in FIG. 1A) supported by the BS 106. Unlike in scenario 1200A, in scenario 1300, the BS 106 broadcasts 1350 system information that does not include a positive indication for UEs to report TA upon establishing/re-establishing/resuming the RRC connection with the second cell (i.e., flag_TA_report is not present or indicates a ‘false’ value). As a result, the UE 102 does not report its full TA to the BS 106, and it then does not receive a second differential k_offset value from the BS 106 for the upcoming SDT procedure. Therefore, after the determination 1354 that is similar to 1254, the UE 102 does not examine whether the difference between the full TA value currently applied by the UE (i.e., the second full TA value) and the first full TA value reported in the procedure 1321 has exceeded the value X_{offset} configured in the first TA report configuration. Further, the UE 102 does not include a TA Report MAC CE is the RRCResume message and then the UE 102 does not receive a Different Koffset MAC CE in the event 1334.

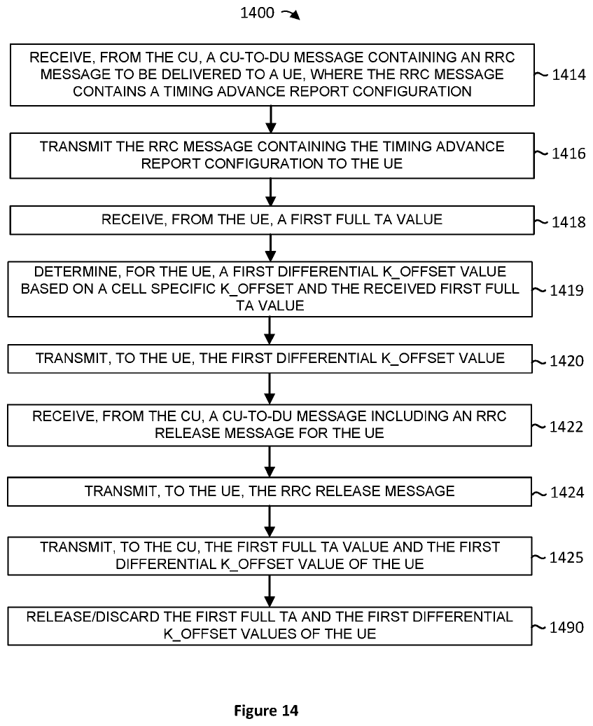

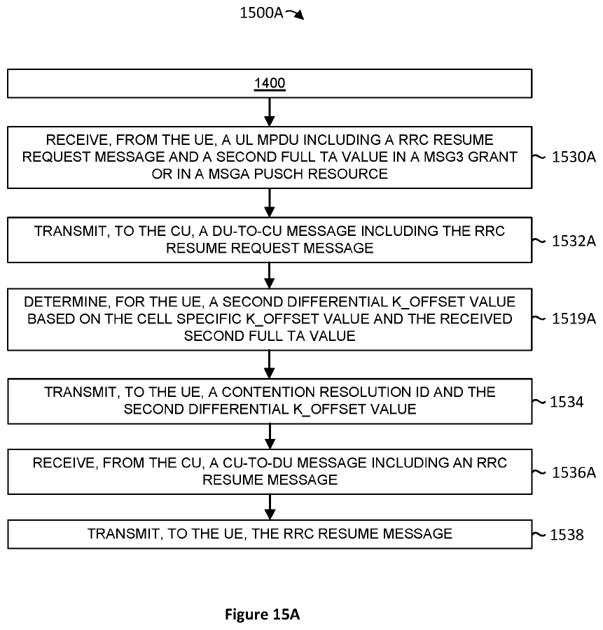

FIG. 14 is a flow diagram of a method 1400 performed by a DU (e.g., DU 174), for determining and handling the differential k_offset value for the UE, according to an embodiment. Initially, the DU receives 1414 (corresponding to the step 814 in FIG. 8), from a CU, a CU-to-DU message including an RRC message to be delivered to a UE, where the RRC message includes a TA report configuration (e.g., the tar-Config IE). The DU then transmits 1416 an RRC message including the TA report configuration to the UE. In response, the DU receives 1418, from the UE, a TA Report MAC CE containing a first full TA value (i.e., common TA+UE-specific TA+N_{TA}) applied by the UE while performing an UL transmission. The DU determines, for the UE, a first differential k_offset value based on the cell-specific k_offset value and the received first full TA value. In one implementation, the DU determines the first differential k_offset value for the UE by subtracting the cell-specific k_offset value from the first full TA value (i.e., differential k_offset=first full TA−cell-specific k_offset).

The DU transmits 1420, to the UE, a differential Koffset MAC CE including the first differential k_offset value determined for the UE, and receives 1422, from the CU, a CU-to-DU message including an RRC release message for the UE, where the RRC release may include a suspendConfig IE. The DU then transmits 1424, to the UE, the RRC release message, and forwards 1425, to the CU, the first full TA value and the first differential k_offset value of the UE. Finally, the DU releases/discards 1490 the first full TA and the first differential k_offset values of the UE.

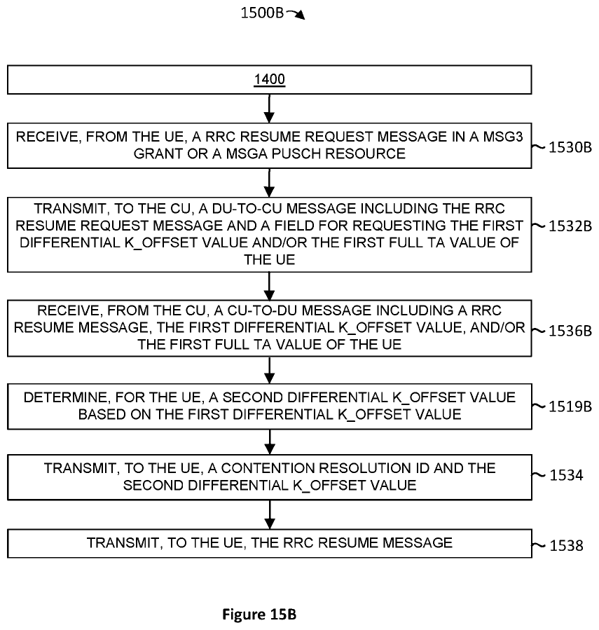

FIG. 15A is a flow diagram of a method 1500A performed by a DU (e.g., DU 174), for providing a differential k_offset value to the UE during an RRC connection resume procedure, according to an embodiment. First, the DU performs the method/procedure 1400 for determining and handling the first differential k_offset value of a UE. The DU then receives 1530A, from the UE, an UL MPDU including an RRC resume request message and a second full TA value in a MSG3 grant or in a MSGA PUSCH resource. In response to the RRC resume request message, the DU transmits 1532A, to a CU, a DU-to-CU message including the RRC resume request message, and then determines 1519A a second differential k_offset value for the UE based on the cell-specific k_offset value and the received second full TA value.

The DU transmits 1534, to the UE, a Contention Resolution ID MAC CE that echoes the first/top 40 bits of the RRC resume request message received at block 1530A, and a Differential Koffset MAC CE that contains the second differential k_offset value determined for the UE. The DU then receives 1536A, from the CU, a CU-to-DU message including an RRC resume message for the UE. Although in this diagram operation 1534 occurs earlier than operation 1536A, operation 1534 may occur later than operation 1536A. Similarly, although in this diagram the Contention Resolution ID MAC CE 1534 is transmitted after operations 1532A and 1519A, it can be transmitted at any time after operation 1530A. Finally, the DU transmits 1538, to the UE, the RRC resume message. The transmissions 1538 and 1534 can be merged if the operation 1536A occurs earlier than the operation (i.e., transmission) 1534.

FIG. 15B is a flow diagram of a method 1500B performed by a DU (e.g., DU 174), for providing a differential k_offset value to the UE during an RRC connection resume procedure, without having the full TA value reported by the UE, according to an embodiment. Initially, the DU performs the method/procedure 1400 for determining and handling the first differential k_offset value of a UE. The DU then receives 1530B, from the UE, an RRC resume request message in an MSG3 grant or an MSGA PUSCH resource. In response to the RRC resume request message, the DU transmits 1532B, to a CU, a DU-to-CU message including the RRC resume request message and a field/IE for requesting the first differential k_offset and/or the first full TA values of the UE. In response, the DU receives 1536B, from the CU, a CU-to-DU message including an RRC resume message. This CU-to-DU message also includes the first differential k_offset value of the UE and/or the first full TA value of the UE. The DU then determines 1519B a second differential k_offset value for the UE based on the first differential k_offset value or on the first full TA value received at 1536B.

The DU transmits 1534, to the UE, a Contention Resolution ID MAC CE that echoes the first/top 40 bits of the RRC resume request message received at 1530B and the second differential k_offset value determined at 1519B for the UE. Although in this diagram the Contention Resolution ID MAC CE is transmitted 1534 after 1532B, 1536B and 1519B, it can be transmitted at any time after 1530B. Finally, the DU transmits 1538, to the UE, the RRC resume message.

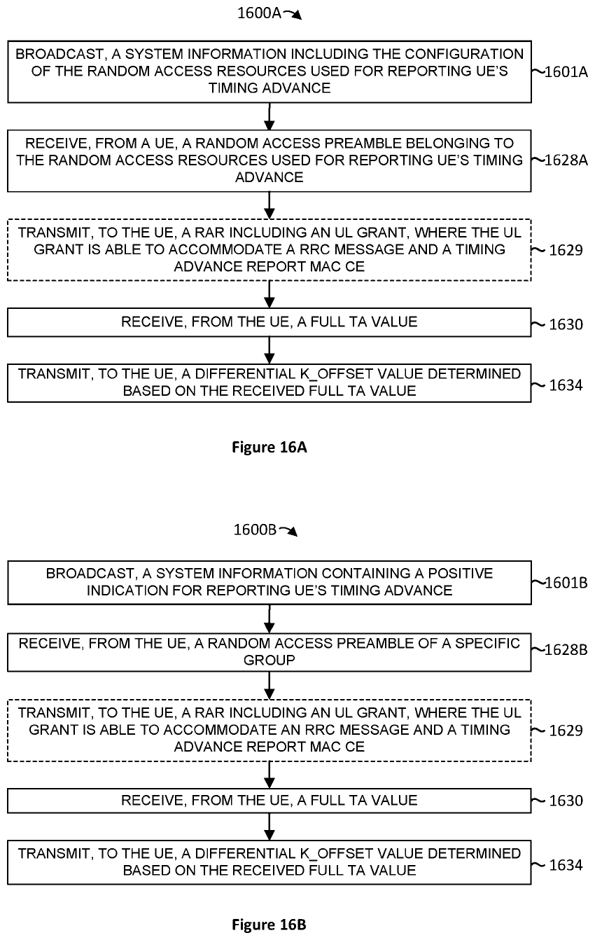

FIG. 16A is a flow diagram of a method 1600A performed by a DU (e.g., DU 174), for providing, to the UE, sufficiently large resources for reporting TA in specific RA procedures (e.g., the RA triggered by the RRC connection resume procedure), according to an embodiment. First, the DU broadcasts 1601A, system information (e.g., a system information block) including a configuration of Random Access resources usable for reporting UE's timing advance. The DU then receives 1628A, from a UE, a random access preamble belonging to the random access resources used for reporting UE's timing advance. After that, the DU transmits 1629, to the UE, a Random Access response including an UL grant for the UE to transmit MSG3, where the UL grant is able to accommodate an RRC message and a TA Report MAC CE. If the preamble received at 1628A belongs to the preamble allocated for the 2-step RA procedure, the DU skips operation 1629. The DU then receives 1630, from the UE, a TA Report MAC CE including a full TA value. Finally, the DU transmits 1634, to the UE, a Differential Koffset MAC CE including a differential k_offset value determined based on the full TA value received at 1630.

FIG. 16B is a flow diagram of a method 1600B performed by a DU (e.g., DU 174), for providing, to the UE, sufficiently large resources for reporting TA in an RA procedure, according to an embodiment. First, the DU broadcasts 1601B system information including a positive indication for UEs to report TA information during the RRC connection establishment/reestablishment/resume procedure. Then the DU receives 1628B, from a UE, a random access preamble belonging to a specific random access preambles group (e.g., RA preambles group B). In response, the DU transmits 1629, to the UE, a Random Access response including an UL grant for the UE to transmit MSG3, where the UL grant is able to accommodate an RRC message and a TA Report MAC CE. If the preamble received at 1628B belongs to the preamble allocated for the 2-step RA procedure, the DU skips 1629. The DU then receives 1630, from the UE, a TA Report MAC CE including a full TA value. Finally, the DU transmits 1634, to the UE, a Differential Koffset MAC CE including a differential k_offset value determined based on the full TA value received at 1630.

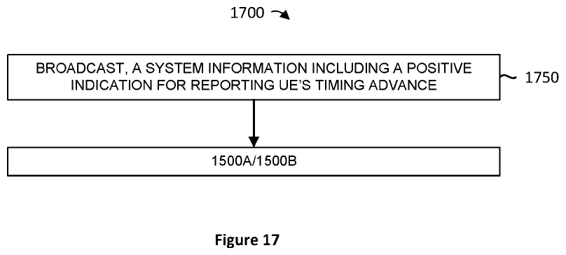

FIG. 17 is a flow diagram of a method 1700 performed by a DU (e.g., DU 174), for controlling via the system information UEs to report TA in the RRC connection resume procedure, according to an embodiment. First, the DU broadcasts 1750 system information (e.g., a system information block) including a positive indication for UEs to report their full TA values during an RRC connection establishment/reestablishment/resume procedure. Method 1700 then includes methods 1500A or 1500B, depending on whether the DU has received a full TA value together with an RRC resume request message from a UE. If the DU has received a full TA value together with an RRC resume request message, the method 1700 proceeds to perform the operations of method 1500A, otherwise the method 1700 proceeds to perform the operations of method 1500B.

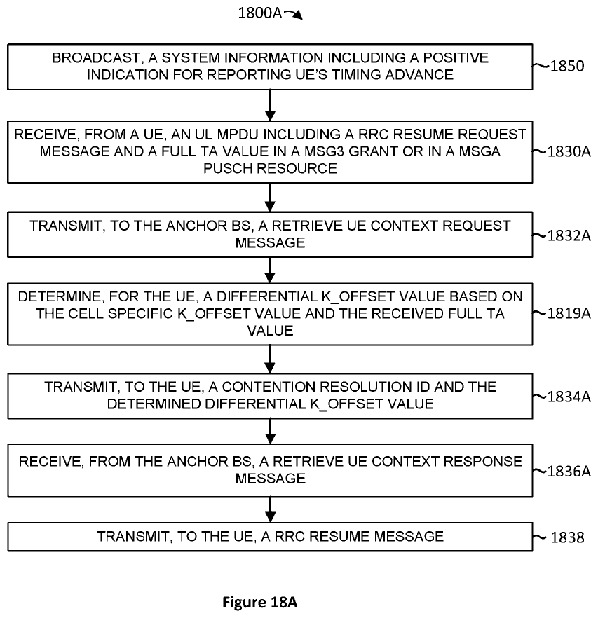

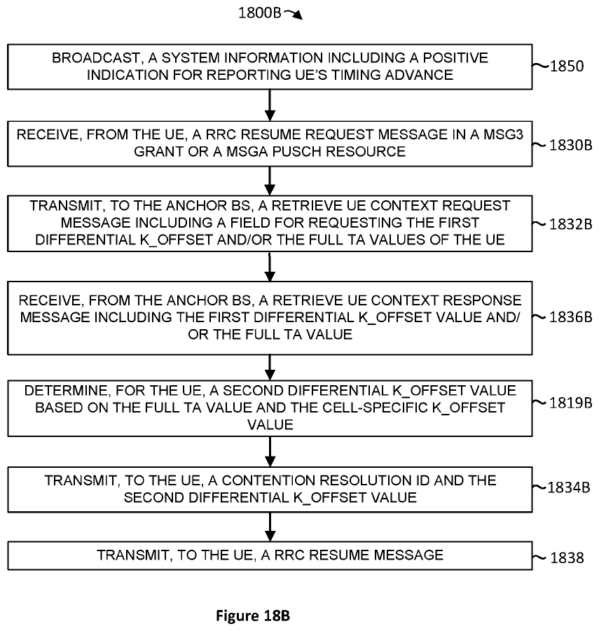

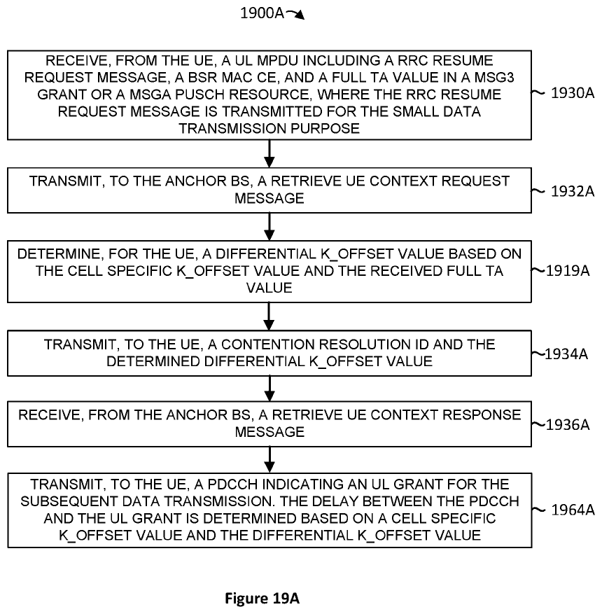

FIG. 18A is a flow diagram of a method 1800A performed by a base station (e.g., BS 106), for determining the differential k_offset value for a UE during an RRC connection resume procedure, according to an embodiment. Initially, at block 1850, the BS broadcasts, system information including a positive indication for UEs reporting full TA value during an RRC connection establishment/reestablishment/resume procedure. The BS receives 1830A, from a UE, an UL MPDU including an RRC resume request message and a full TA value in a MSG3 grant or in a MSGA PUSCH resource. The BS then transmits 1832A, to the anchor BS, a Retrieve UE Context Request message. The BS determines 1819A a differential k_offset value for the UE based on the cell specific k_offset value and the received full TA value.

The BS then transmits 1834A, to the UE, a Contention Resolution ID MAC CE that echoes the first/top 40 bits of the RRC resume request message received at 1830A and a Differential Koffset MAC CE that includes the determined differential k_offset value. In response to the request transmitted at 1832, the BS receives 1836A, from the anchor BS, a Retrieve UE Context Response message that may include a TA report configuration of the UE. Although in this diagram operation 1834A occurs earlier than operation 1836A, it is possible for operation 1834A to occur later than operation 1836A. Similarly, although in this diagram the Contention Resolution ID MAC CE is transmitted after operations 1832A and 1819A, it can be transmitted at any time after operation 1830A. Finally, the BS transmits 1838, to the UE, an RRC resume message. The operations 1838 and 1834A can be merged if operation 1836A occurs earlier than operation 1834A.

FIG. 18B is a flow diagram of a method 1800B performed by a base station (e.g., BS 106), for determining the differential k_offset value for a UE during an RRC connection resume procedure, without having the full TA value reported by the UE according to an embodiment. First, the BS broadcasts 1850 system information including a positive indication for reporting UE's full TA value during the RRC connection establishment/reestablishment/resume procedure. Then, the BS receives 1830B, from a UE, an UL MPDU including an RRC resume request message in a MSG3 grant or in a MSGA PUSCH resource. At 1832B, the BS transmits, to the anchor BS, a Retrieve UE Context Request message including a field for requesting the first differential k_offset and/or the full TA values of the UE. The BS then receives 1836B, from the anchor BS, a Retrieve UE Context Response message including the first differential k_offset value and/or the full TA value of the UE. The Retrieve UE Context Response may also include a TA report configuration of the UE. The method 1800 then proceeds with operation 1819B, according to which the BS determines a second differential k_offset value for the UE based on the full TA value and the cell-specific k_offset value of the cell currently selected by the UE. In some implementations, the BS determines, for the UE, the second differential k_offset value based on the first differential k_offset value of the UE.

The BS transmits 1834B, to the UE, a Contention Resolution ID MAC CE that echoes the first/top 40 bits of the RRC resume request message received at 1830B and a Differential Koffset MAC CE that includes the second differential k_offset value. Although in this diagram the Contention Resolution ID MAC CE is transmitted after 1832B, 1836B and 1819B, it can be transmitted at any time after block 1830B. Finally, the BS transmits 1838, to the UE, an RRC resume message. The block 1838 and 1834B can be merged.

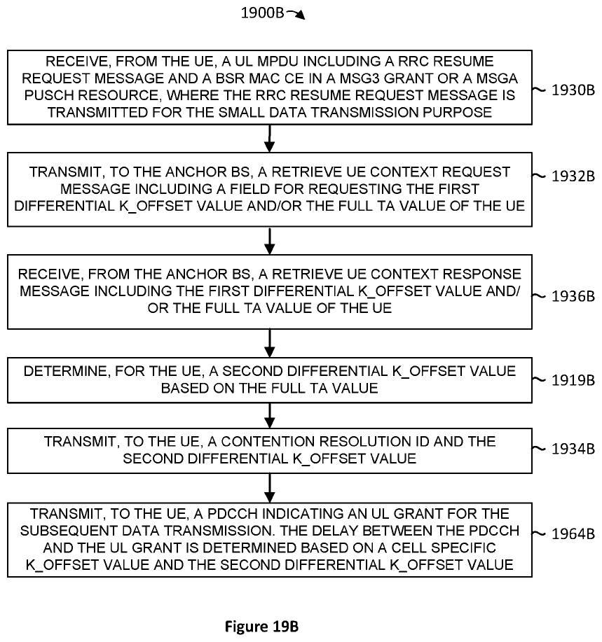

FIG. 19A is a flow diagram of a method 1800A performed by a base station (e.g., BS 106), for determining a differential k_offset value for a UE in an SDT procedure, according to an embodiment. First, the BS receives 1930, from a UE, an UL MPDU including an RRC resume request message, a BSR MAC CE, and a full TA value in a MSG3 grant or in a MSGA PUSCH resource, where the RRC resume request message is transmitted for the SDT purpose. The BS then transmits 1932A, to an anchor BS to which the UE was connected before entering an inactive state, a Retrieve UE Context Request message. The BS determines at 1919A a differential k_offset value for the UE based on the cell specific k_offset value and the received full TA value. The BS transmits 1934A, to the UE, a Contention Resolution ID MAC CE that echoes the first/top 40 bits of the RRC resume request message received at 1930A and a Differential Koffset MAC CE that includes the determined differential k_offset value. In response to the request transmitted at 1932A, the BS receives 1936A, from the anchor BS, a Retrieve UE Context Response message that may include a TA report configuration of the UE. Although in this diagram, operation 1934A occurs earlier than operation 1936A, operation 1934A may occur later than operation 1936A. Similarly, although in this diagram the Contention Resolution ID MAC CE is transmitted 1934A after operations 1932A and 1919A, it can be transmitted at any time after operation 1930A. Finally, the BS transmits 1964A, to the UE, a PDCCH indicating an UL grant for the subsequent data transmission, where the delay between the PDCCH and the UL grant is determined based on a cell specific k_offset value and the differential k_offset value of the UE.

FIG. 19B is a flow diagram of a method 1900B performed by a base station (e.g., BS 106), for determining a differential k_offset value for a UE during an RRC connection resume procedure, without having the full TA value reported by the UE, according to an embodiment. Initially, the BS receives 1930B, from a UE, an UL MPDU an RRC resume request message and a BSR MAC CE in a MSG3 grant or a MSGA PUSCH resource, where the RRC resume request message is transmitted for the SDT purpose. The BS transmits 1932B, to an anchor BS (to which the UE was connected before entering the inactive state), a Retrieve UE Context Request message including a field for requesting the first differential k_offset value and/or the full TA value of the UE. The BS then receives 1936B, from the anchor BS, a Retrieve UE Context Response message including the first differential k_offset value and/or the full TA value of the UE. The Retrieve UE Context Response may also include a TA report configuration of the UE.

Then, the BS determines 1919B a second differential k_offset value for the UE based on the full TA value and the cell-specific k_offset value of the cell currently selected by the UE. In some implementations, the BS determines, for the UE, the second differential k_offset value based on the first differential k_offset value of the UE. The BS transmits 1934B, to the UE, a Contention Resolution ID MAC CE that echoes the first/top 40 bits of the RRC resume request message received at block 1930B and a Differential Koffset MAC CE that includes the second differential k_offset value. Although in this diagram the Contention Resolution ID MAC CE is transmitted at 1934B after operations 1932B, 1936B and 1919B, operation 1934B can occur at any time after operation 1930B.

Finally, the BS transmits 1964B, to the UE, a PDCCH indicating an UL grant for the subsequent data transmission, where the delay between the PDCCH and the UL grant is determined based on a cell specific k_offset value and the second differential k_offset value of the UE.

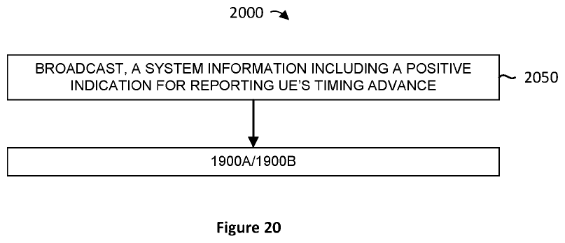

FIG. 20 is a flow diagram of a method 2000 performed by a BS (e.g., BS 106), for controlling via the system information whether UEs report TA in an SDT procedure according to an embodiment. First, the BS broadcasts 2050 system information including a positive indication for UEs to report their full TA values during the RRC connection establishment/reestablishment/resume procedure. Method 200 then proceeds with operations of methods 1900A or 1900B, depending on whether the BS has received a full TA value together with an RRC resume request message from a UE. If the BS has received a full TA value together with an RRC resume request message, the method 2000 continues with operations of method 1900A, otherwise the method 2000 continues with operations of method 1900B.

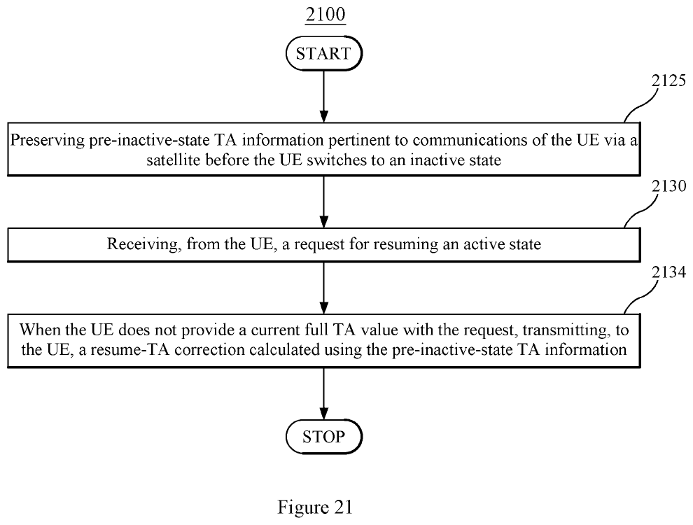

FIG. 21 is a flow diagram of a method 2100 performed by an NE (e.g., a BS or a DU of a distributed BS) connected to a UE, according to an embodiment. The method 2100 includes preserving 2125 (which is similar to 825, 1425) pre-inactive-state TA information pertinent to communications of the UE via a non-terrestrial network before the UE switches to an inactive state (e.g., 826). Method 2100 further includes receiving 2130 (similar to 830), from the UE, a request for resuming an active state, and when the UE does not provide a current full TA value with the request, transmitting 2134 (similar to 834), to the UE, a resume-TA correction calculated using the pre-inactive-state TA information.

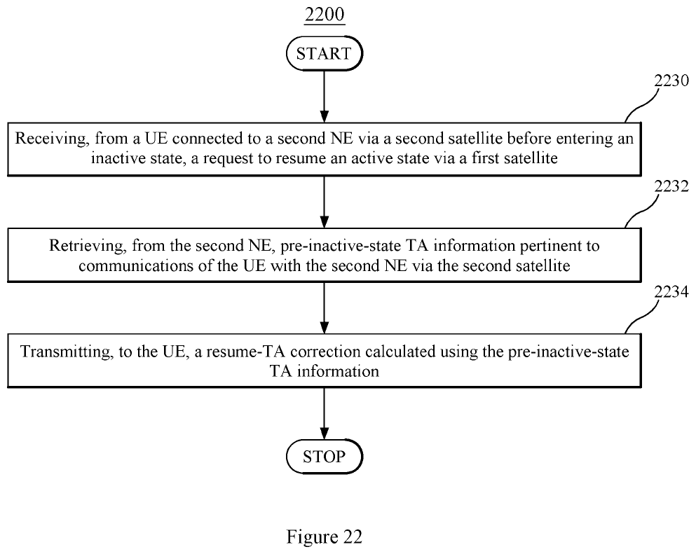

FIG. 22 is a flow diagram of a wireless communication method 2200 performed by an NE (e.g., a BS or a DU of a distributed BS) according to an embodiment. The method 2200 includes receiving 2230 (similar to 1030), from a UE connected to a second NE via a second satellite before entering an inactive state, a request to resume an active state, via a first satellite. The method 2200 further includes retrieving 2232 (which is similar to 1032), from the first NE, pre-inactive-state TA information pertinent to communications of the UE with the first NE via the first satellite and transmitting 2234 (which is similar to 1034), to the UE, a resume-TA correction calculated using the pre-inactive-state TA information.

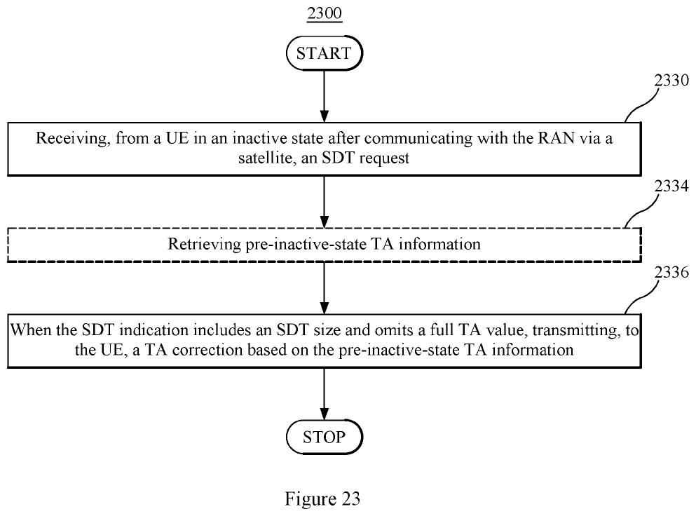

FIG. 23 is a flow diagram of a communication method 2300 performed by an NE (e.g., a BS or a DU of a distributed BS) according to an embodiment. The method 2300 includes receiving 2330 (which is similar to 1130), from a UE in an inactive state after communicating with the RAN via a non-terrestrial network, an SDT indication. The method 2300 further includes, transmitting 2334 (which is similar to 1134), to the UE, a TA correction based on pre-inactive-state TA information, when the SDT indication includes an SDT size and omits a full TA value. Optionally (as suggested by the dashed-line box), the method 2300 may include retrieving 2332 the pre-inactive-state information.

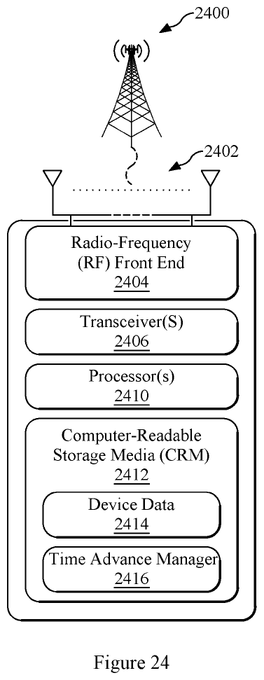

FIG. 24 is a block diagram of a wireless communication device 2400 (e.g., BS 106 or DU 174) configured to perform the above-described methods for managing TA when an inactive UE resumes a RAN connection and/or initiates an SDT procedure according to an embodiment. The wireless communication device 2400 includes antennas 2402 connected to a radio frequency (RF) front end 2404, and at least one RF transceiver 2406 (such as, an LTE transceiver, a 5G NR transceiver, or another transceiver) for communicating via RAN (NTN) with UEs. The antennas and the RF front end can be tuned to one or more frequency bands (e.g., subcarriers), for example, as defined by 3GPP LTE, 5G NR, and 6G communication standards and implemented by respective transceivers. Wireless communication device 2400 also includes one or more processor(s) 2410, and computer-readable storage media, CRM, 2412. Processor(s) 2410 may be single or multiple-core processors, and CRM 2412 includes any suitable memory/storage other than propagating signals. For example, memory/storage can include random-access memory (RAM), static RAM (SRAM), dynamic RAM (DRAM), non-volatile RAM (NVRAM), read-only memory (ROM), and/or flash memory useable to store a device data 2414 and a Time Advance manager 2416 for implementing various techniques described in this document. CRM 2412 stores instructions executable by processor(s) 2410 to facilitate user-plane communication, control-plane signaling and user interaction. The TA report manager 2416, which may be implemented not only as software but also as hardware logic and/or circuitry, causes various steps and actions associated with TA information.

In the above figures, description for one of the above figures can apply to another of the above figures. Any event or operation described above can be optional. For example, an event or operation with dashed lines can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1-17. (canceled)

18. A wireless communication method performed by a network entity, NE, connected to a user equipment, UE, the method comprising:
preserving pre-inactive-state time advance, TA, information related to the UE communicating via a non-terrestrial network, NTN, cell employing a satellite before the UE switches to an inactive state;
receiving, from the UE, a request for resuming an active state; and
when the UE does not provide a current full TA value with the request, transmitting, to the UE, a resume-TA correction to be applied for communications after the UE resumes the active state, the resume-TA correction being calculated using the pre-inactive-state TA information.

19. The wireless communication method of claim 18,
wherein the resume-TA correction corresponds to a Differential Koffset as defined in 3GPP technical specifications.

20. The wireless communication method of claim 18,
wherein the pre-inactive-state TA information includes at least one of a pre-inactive-state full TA value or a pre-inactive-state TA correction.

21. The wireless communication method of claim 18, further comprising:
upon receiving, from the UE, the current full TA value, transmitting, to the UE, the resume-TA correction calculated using the current full TA.

22. The wireless communication method of claim 18, further comprising:
transmitting, to the UE, a TA report configuration; and
receiving, from the UE, the pre-inactive-state TA information to be preserved in a TA report prepared according to the TA report configuration.

23. The wireless communication method of claim 22, further comprising:
transmitting, to the UE, a time difference threshold with the TA report configuration, for enabling the UE to transmit updated TA information when a difference between an evaluated full TA and a latest reported full TA exceeds the time difference threshold.

24. The wireless communication method of claim 18, further comprising:
transmitting, to the UE, a positive indication requesting the UE to report TA information.

25. The wireless communication method of claim 18, wherein:
the NE is a distributed unit, DU, of a distributed base station that also includes a central unit, CU,
the preserving of the pre-inactive-state TA information includes transmitting the pre-inactive-state TA information from the DU to the CU.

26. The wireless communication method of claim 25, the method further comprising:
retrieving the pre-inactive-state TA information from the CU.

27. The method of claim 18, wherein the NE is a base station.

28. A wireless communication method performed by a first network entity, NE, the method comprising:
receiving, via a first satellite, from a UE in an inactive state after communicating with a second NE via a second satellite, a request to resume an active state;
retrieving, from the second NE, pre-inactive-state time advance, TA, information related to UE communications with the second NE via the second satellite before entering the inactive state; and
transmitting, to the UE via the first satellite, a resume-TA correction to be applied for UE communications with the first NE after the UE resumes the active state, the resume-TA correction being calculated using the pre-inactive-state TA information.

29. The wireless communication method of claim 28, further comprising:
broadcasting system information including a cell-specific TA and a positive indication for the UE to report TA information.

30. A wireless communication method performed by a first network entity, NE, in a radio access network, RAN, the method comprising:
receiving, from a UE in an inactive state after communicating with the RAN via a non-terrestrial network, NTN, cell employing a satellite, a small data transmission, SDT, indication; and
when the SDT indication includes an SDT size and omits a full TA value, transmitting, to the UE, a TA correction based on pre-inactive-state time advance, TA, information of the UE communicating with the RAN via the NTN cell prior to entering the inactive state.

31. The wireless communication method of claim 30, further comprising:
retrieving the pre-inactive-state TA information.

32. The wireless communication method of claim 31, wherein the retrieving of the pre-inactive-state TA information comprises:
transmitting a TA information request to a second NE, which was a destination of the communications of the UE using the satellite before the UE entered the inactive state; and
receiving the pre-inactive-state TA information from the second NE in response to the TA information request.

33. The wireless communication method of claim 31, wherein
the NE is a distributed unit, DU, of a distributed base station that also includes a central unit, CU, and
the retrieving of the pre-inactive-state TA information comprises:
transmitting a TA information request to the CU; and
receiving the pre-inactive-state TA information from the CU.

34. The wireless communication method of claim 30, wherein the pre-inactive-state TA information includes at least one of a pre-inactive-state full TA value or a pre-inactive-state TA correction.

35. A wireless communication device, comprising:
a transceiver configured to receive, from a user equipment, UE, in an inactive state, a request to resume an active state or a small data transmission, SDT, indication, the UE communicating with the wireless communication device via a satellite; and
a processor configured to selectively include a time advance, TA, correction in a response to the request or to the SDT indication, the TA correction being calculated using pre-inactive-state TA information related to UE communications prior to entering the inactive state.

36. The wireless communication device of claim 35, wherein the processor includes the TA correction in the response to the request to resume the active state when the UE does not provide a current full TA value with the request.

37. The wireless communication device of claim 35, wherein the processor includes the TA correction in the response to the SDT indication when the SDT indication includes an SDT size and omits a full TA value.
